(19) United States
(12) Patent Application Publication
(10) Pub. No.: US 2008/0059382 A1
(43) Pub. Date: Mar. 6, 2008

(54) Computer System and Method for Trading Clipper Financial Instruments

(76) Inventor: Adam Burczyk, Chicago, IL (US)

Correspondence Address: VEDDER PRICE KAUFMAN & KAMMHOLZ, 222 N. LASALLE STREET, CHICAGO, IL, 60601, US

(21) Appl. No.: 11/849,266

(22) Filed: Sep. 1, 2007

Related U.S. Application Data
(60) Provisional application No. 60/841,772, filed on Sep. 1, 2006.

(51) Int. Cl. G06Q 40/00; G06Q 20/00

(52) U.S. Cl. 705/36 R; 705/35; 705/37; 705/39

(57) ABSTRACT

A computer and data-processing system and method for specifying, trading, and clearing Clipper financial instruments. A Clipper is a new, “all-in” margined derivative that can be applied to almost any referenced Underlying financial instrument. A Clipper's value at expiration is calculated by first subtracting the negotiated face-value price for an Underlying as of the time of inception of the trade, from the observed face-value price of that same Underlying at the time of expiration, and then capping that difference to a maximum specified amount of gain or loss, called a “clip limit.” A “clip limit” is specified by the two counterparties at the time of inception of the trade. Such a “clip limit” dually serves as the “all-in” margin that could be required from the two counterparties from a clearinghouse to guarantee any profit or loss outcome of the trade. The maximum positive or negative value of the Clipper can be settled by such a clearinghouse on a cash or cash equivalent payment basis, fully funded from the “all-in” margin of the losing counterparty.

This application claims priority to provisional application Ser. No. 60/841,772 filed Sep. 1, 2006.

### BACKGROUND OF THE INVENTION

1. Field of Invention

The present invention relates to a computer and data-processing system and method for specifying, trading, and clearing Clipper derivatives. More particularly, it relates to a computer processing method whereby Clipper derivatives on stocks, bonds, currencies, commodities, or other Underlying financial instruments' (“Underlying's”) can be traded between counterparties in an over-the-counter electronic trading environment, or, alternatively, in a regulated exchange environment. The invention also relates to the means by which counterparties may elect to clear and settle such trades at a clearinghouse, which can collect margins and act as a guarantor of trade performance to both counterparties.

2. Description of Prior Art

### Example of Speculation in Stocks.

Many investors in long or short positions in stocks are speculators who have measurable objectives with respect to their deployments of definite amounts of sunk capital over definite periods of finite time. These speculators have a firm sense of how long they want to hold a long or short position in an Underlying, which is called a “time horizon.” These same speculators also have a firm sense of how much money they expect to make after an expected move is made in the price of that Underlying, taking place before the end of that time horizon, which is called a “targeted return.”

For example, a long trader with a cash account may have a view that the $106.87 price in XYZ stock will, during the next 5 business days, go up $2, to $108.87. The “time horizon” in this example is 1 week. The “targeted return” in this example is a “hard return” of $2, because the long trader earns $2 from this movement of the underlying stock XYZ.

To summarize: the long trader, spending $106.87 to earn a prospective $2 in “hard return,” will obtain an almost 2% return to the amount of capital deployed, which appears to be a decent return on such tied-up capital for a week's time.

In the United States, the Federal Reserve has established Regulation T, which states that up to 50% of an overall stock purchase may be borrowed by a retail investor, that is, held against a certain amount of value in a margin account. In this example, $53.44 plus some borrowing costs under a “brokerage rate” for the second $53.44, will obtain the same $2 in “hard return.”

To summarize: the long trader with a Regulation T margin account, spending $53.44 and paying some additional “brokerage rate” interest to earn nearly a prospective $2 in “hard return” will obtain nearly almost 4% return to the amount of capital deployed, which appears to be a much better return on tied-up capital than the first example. The remaining $53.44 that was not required to be spent to pay for the $106.87 stock can be deployed usefully elsewhere, perhaps to be invested in Treasury Bills, or in other financial investments.

### General Problem of too Much Invested Capital to Obtain Relatively Little in Returns.

But if the speculative trader is known to have a time horizon of a week, and a targeted return of $2, why is that trader required to spend $106.87 or $53.44 to make such a paltry relative return of almost 2% or 4%? Why not risk just $2 in margins to get an additional “hard return” of $2?

Unfortunately, the global capital markets have not found a way to facilitate such a trader with a single “limited upside, limited downside” all-in margined instrument with a maximum gain or loss ($2 in this example) is a targeted return that is mapped equidistantly up and down from a set price of an underlying stock as of the start time of the trade ($106.87 in this example), whose expiration is compatible with “time horizon” requirements (1 week in this example) and whose margins (again $2, which is the same amount as the maximum gain or loss) are a close approximation to “targeted return” requirements.

In other words, the prior art has not found a way to provide speculators who already have pre-established time horizon, risk, return, and sunk capital objectives, with a financial derivative that allows them to “clip” or “limit” the extreme upside or downside movements in an underlying to an acceptable amount ($2), so as to “clip” or “limit” the sunk capital requirements required to margin the derivative position (the same $2).

In most instances, the prior art in capital markets requires a speculator to furnish an initial margin amount (that is tied up over the period of the held position) that is many times larger than the speculator's “firm sense” of expected targeted return. This results in a poor utilization of capital because, conceptually, less initial margins might have been furnished at the time of the trade to obtain that same targeted return.

Unless the amount of margins required to trade an underlying financial instrument happen to be coincidentally identical to the amount of a trader's targeted “hard return,” it is impossible to discover any financial instrument in the prior art that will be simultaneously margined and capital efficient, that is, will “right size” the amount of required deployed capital in the form of margins to match the “hard return” objectives of that speculative trader.

### SUMMARY OF THE INVENTION

The invention describes a computerized method and system of specifying, settling and trading a clipper financial instrument between a Buyer and Seller. A clipper is a financial derivative that allows a Buyer and Seller to “clip” or “limit” the extreme upside or downside movement in an underlying to an acceptable amount. The method and system of the present invention involves a Buyer and Seller jointly selecting an Underlying vehicle for the Clipper financial instrument, the starting time and date, and expiration time and date for the Life of the Clipper, the clip limit amount and starting price and the number of units for the Clipper, and thereafter the Buyer and Seller selecting an observed price for the Underlying Investment at time of expiration and subtracting the starting price from the observed price to obtain a value for settlement of the trade.

One aspect of the present invention is realized capital savings because of the performance of a movement in a stock price and not the stocks, or other investment, itself.

Another aspect of the present invention is the fact that gains and losses are limited to both parties in the trade.

And yet another aspect of the present invention is that there is no additional premium in trading the Clipper financial instrument for each party.

Another aspect of the present invention is that the Life of the Clipper financial instrument may be set to any desired length of time.

Another aspect of the present invention is that the trading of a Clipper financial instrument involves the tracking of a single instrument compared to multiple instruments when trading standard options to achieve the same or similar return.

The foregoing, and other objects, aspects, and advantages of the invention of the specification of the clipper financial instrument will be better understood from the following detailed drawing of a clipper exposure.

### BRIEF DESCRIPTION OF THE DRAWING

The present invention will be understood and appreciated more fully from the following detailed description in conjunction with the drawing in which:

FIG. 1 is a block diagram of a time line associated with the inception, start time, and end time at expiration of a clipper financial instrument, and also of a schematic “bell curve” of XYZ stock, with regions of the future distribution of price outcomes at the time of clipper expiration. The bell curve is a simple aid to visualizing the payoff function of the clipper, but should not be used to consider the actual shape of the future probability distribution, because a future probability distribution is rarely as symmetrical, or as roundly peaked, as a well-formed bell curve.

### DETAILED DESCRIPTION OF THE INVENTION

The following glossary may be helpful in understanding words and phrases utilized in the specification; however, it is not intended to be limitative.

### Glossary

### Aggressor

The counterparty placing an order that is matched to an existing resident order under one type of matching algorithm on an electronic trade facility.

### All-In Margins

The capital required to fund a Clipper trade, that is equal to the worse possible outcome of the trade, therefore eliminating any risk of default.

### Bell Curve

A graph or data set organized to show the frequency of occurrence of each possible outcome of a repeatable event observed over a period of time.

### Buyer

A clipper counterparty who stands to gain from an appreciation and increase in an underlying price.

### Clearinghouse

A Derivatives Clearing Organization (DCO) duly designated, recognized, and regulated by the CFTC, to provide clearing services.

### Clip Limit

The absolute value of the maximum gain or loss of a stand alone Clipper instrument.

### Clip Limit Down

The absolute value of the clip limit subtracted from the current mid-bar value of a Clipper order.

### Clip Limit Up

The absolute value of the clip limit added to the current mid-bar value of a Clipper order.

### Clipper

A financial instrument whose structure is that of a derivative referencing an underlying, whose Buyer or Seller position has a settlement value that is determined by subtracting the negotiated start price of the derivative from the observed value of the underlying as of the expiration time of the derivative, and further capping that difference by a constant absolute value of gain or loss, where a settlement value of gain requires payment of that capped difference from Buyer to Seller, and where a settlement value of loss requires payment of that capped difference from Seller to Buyer.

### Co-Select

A referenced Underlying can be co-selected by the two counterparties by coincidence, that is, by selecting the Underlying at the same “place” at the same time, without any pre-mediated coordination or collusion. A “place” may be the virtual space of a computerized environment, like at the bulletin board or quotation display of an electronic trade facility, where Buyers and Sellers congregate by means of telecommunication networks to negotiate, offer, bid, or request to make Clipper trades.

### Contract Size

The number of Underlying units that the Clipper contract is based upon (dependent claim).

### Counterparty

An individual engaging as either Buyer or Seller in one side of a Clipper transaction.

### Debit Model

The accounting structure of a clearinghouse that requires a market participant to pre-fund the maximum possible loss that can be experienced for any trade into the system.

### Derivative

Financial instruments whose price and value derive from the value of assets Underlying them.

### Downside

A range of prices that includes the current market price and all prices lower than the current market price.

### Electronic Trade Facility (ETF)

A trading facility that operates via an electronic or telecommunications network instead of a physical trading floor, maintaining an automated audit trail of transactions, as defined by the Commodity Futures Modernization Act of 2000 (CFMA).

### End-Time

The End-Time of a Clipper trade or order is defined as the pre-specified date and time that an individual sets their Clipper to expire. A specific calendar month, day and year, as well as a specific hour, minute, and second must be identified as the End-Time, and the Clipper life will expire at that particular second.

### Expiration

The specific date and time that an exposure is set to cease trading, that is determined by an applied expiration basis or custom date and time specification.

### Future

A contract between two counterparties which states that one counterparty will sell to the other some fixed amount of an underlying security for a specified price at some fixed time in the future.

### Inception

The trade inception is defined as the time at which the two legal persons, having already negotiated the specifications of the Clipper trade, have been matched or recognized as such by an electronic trade facility, where one legal person is recognized as the Buyer and the other as the Seller. The date and time stamp of the matched trade is considered the recognized time of trade inception.

### Life of the Clipper

The amount of time between the Start-Time and End-Time of the Clipper trade, that is defined by the time horizon co-specified by the counterparties.

### Long Trader

One who has bought a contract to establish a market position and who has not yet closed out this position through an offsetting sale; the opposite of short.

### Matching Algorithm

The method in which an electronic trade facility is programmed to match orders is called a matching algorithm. Matching algorithms, may include, but are not limited to, the manual or programmed prioritization of order attributes for the purposes of matching, or the manual or automated distribution of matches among specified counterparties.

### Mid-Bar

See Start-Price.

### Negotiated Clipper Trade

Two legal persons may negotiate a trade by communicating via a verbal agreement, or through any form of telecommunication or wire communication through an electronic trade facility, the agreed specifications of which must include:
1) The persons on each side of the trade, acting as Buyer and Seller counterparties (Buyer/Seller).
2) The Underlying financial instrument (Underlying),
3) The starting date and time for the Life of the Clipper (Start-Time),
4) The expiration date and time for the Life of the Clipper, (Expiration),
5) The Start Price for the Clipper, (Start Price) alternatively known as (Mid-Bar)
6) The maximum gain/loss amount for the Clipper, (Clip Limit) (Clip Limit Amount)
7) The number of units of the Clipper, (Quantity)
8) The number of Underlying units the contract is based upon, (Contract size).

### Pay Off Function

For an instrument whose value is based on the price of an underlying security at some future time, this is the function mapping any possible end price of that underlying security to the resulting payoff at that end price.

### Pin Risk

A risk presented to the writer of an option when the underlying security settles close to the strike price of that option. In this situation, the writer cannot be sure whether or not the holder will choose to exercise the option. If the writer makes the wrong prediction, he can end up with an undesired open position in the underlying security.

### Option

A contract between two counterparties that gives the holder (Buyer) the right, but not the obligation, to make some transaction on an underlying security at some future time. The other counterparty, who would take the other side of this transaction, is called the writer or Seller of the option. In a call option, the holder has the right to buy the underlying security at some specified price. In a put option, the holder has the right to sell the underlying security at some specified price. If the holder of an option chooses to make the optional transaction, they are said to exercise the option.

### Resident

The counterparty placing an order which persists in the Contract market space to be matched against eligible incoming orders, until filled, expired, or cancelled.

### Right-Sized

A term used when targeting a specific value or value range of the payoff function of a financial instrument.

### Security

Generally, a fungible, negotiable interest representing financial value. Securities are broadly categorized into debt and equity securities.

### Seller

A Clipper counterparty who stands to gain from a depreciation and decrease in an Underlying price.

### Short Trader

One who has sold a contract to establish a market position and who has not yet closed out this position through an offsetting purchase; the opposite of a long position.

### Start-Price Alternatively Called (Mid-Bar)

The Underlying price that is used as the starting value of applied clip limits of Clipper orders.

### Start-Time

The Start-Time of a Clipper trade must specify a calendar year, month, and day, as well as a specific hour, minute, and second, at which the Life of the Clipper begins. The means by which a Start-Time is selected must be specified at trade inception.

### Tail-Risk

The probability that an outcome will reside in the extreme ends of a probability curve. This term is derived from a visual analysis of a Standard Distribution graph that shows the show probability of an outcome at the far ends of the graph.

### Targeted Return

A calculated value of a monetary return on a specified investment that is used in a particular trading strategy.

### Time Horizon

The time in which the Life of the Clipper is defined by, as it is co-specified by counterparties by identifying an exact Start-Time and End-Time for the Clipper trade.

### Trade Match

A pre-matched trade may be entered into a paper or computerized system as a single submission simultaneously stating the buy or sell intentions of the Buyer and Seller, along with the specifications of Underlying, Start-Time, Expiration, Mid-Bar, Clip Limit, Quantity and Contract size. Separately-entered orders submitted by the Buyer and Seller may be manually or automatically matched at the electronic trade facility, using a matching algorithm that is calculated by facility personnel or by automated programming. In such a system, the first order is considered a resident order, by nature of it residing on the system persisting until cancelled or matched, and the other order is considered an aggressor, by nature of it entering into the system after the first order and being matched against it using the method calculated by the matching algorithm. Once two individuals have been recognized as matched by the system, they are deemed to be counterparties.

### Underlying

The referenced asset that a derivative is based upon. The Underlying can be, but is not limited to, a specified stock, bond, currency, commodity, or some other financial instrument or economic event or index of interest whose value, price, or changing variable can be referenced and reported for the purpose of negotiating a Start Price for the Clipper, and for the purpose of settling an end price for the Clipper. The price movement of this Underlying is used to calculate gains and losses for every Clipper trade.

### Unitary

Of or pertaining to the use of units.

### Upside

A range of prices that includes the current market price, and all prices higher than the current market price.

What is disclosed is a general computerized method and system of trading financial instruments between a Buyer and a Seller. Within the scope of this disclosure, the terms Buyer and Seller are to be construed as owners, traders, managers, holders, or enablers of the trade of the financial instrument. As a way of a non-limiting example, these Buyers and Sellers of financial instruments can include a private individual, a stock broker, a trader, a portfolio manager, an actor with a financial institution, a corporate entity, a trust, or any other judicially or non judicially entity capable of acting on the financial instrument.

Also within the scope of this disclosure, the term trading of a financial instrument is understood by one of ordinary skill in the art as the capacity to exchange contracts, commodities, options, equity, bonds, stocks, or any other financial between the above described Buyer and Seller over a trading platform or a trading facility in an alternate terminology. Trading platforms interface with Buyers and Sellers, and obtain, store, manage and manipulate a very wide range of useful and needed data, using software enabled within hardware. Data may be obtained from storage such as a database or archives, or may be streamed from a source of evolving data such as a phone conversation, a camera feed, or any other source of information. Data may also be created by the transformation of data sources or other input information using software platforms into a newly created and useful data. Data includes but is not limited to digital data found on databases, analog data, data stored permanently or temporarily in computer memory, data created or transformed by hardware or software.

Trading platforms, as contemplated within the scope of this disclosure includes any data processing and storage device or assembly of devices found individually or connected in a network over local area networks, over the internet, over a wireless network, over an AM/FM band, or any other network connected via hardware using a protocol of communication or a plurality of protocols of communications. Trading platforms are generally include computing capacities enabled by one or a plurality of microprocessors located on a computer or on computer servers connected to boards or other hardware and acting in conjunction with memory, clocks, and power sources to enable software to operate and process data according to the particularities of the software. Trading platforms include computer interfaces capable of data input from users or software operators such as screens, keyboards, mouse, digital pen, touch screen, light pens, voice commands, or the like.

As a way of non limiting example, a possible trading platform or a trading facility may include a first computer station at a first location used by the Buyer and a second computer station at a second location used by the Seller, both stations connected directly or via a server through a network such as the internet. What is known by one of ordinary skill in the art is the use of wireless hand held devices, remote devices such as voice operated terminals, computer terminals, network terminals to serve as either a Buyer terminal or a Seller terminal as part of the trading platform. What is also known is the use of a single terminal having a plurality of input devices for data entry either at a single or a plurality of locations to enable trading over the trading platform.

Within the scope of this disclosure the system and the software disclosed is considered as part of a computerized method and system of trading a Clipper financial instrument. The different functions and features disclosed may be part of the overall software system operating on the trading platform and used as described here above by a Buyer and a Seller.

What is also disclosed and contemplated is the use of security measures, protocols, certificates, control on access, log-in procedures sufficient to protect the system from unwanted interferences.

In addition, a financial instrument is disclosed. It is identified as a Clipper and is based upon an Underlying stock, bond, currency, commodity or other financial instrument that has a value price that can be reported. The Clipper financial instrument limits potential losses and gains on the Underlying vehicle.

In one embodiment, a trader is acting as both a Buyer and a Seller. The Buyer and the Seller select a financial instrument, said to be a referenced underlying financial instrument. On the trading platform, a start time and associated date for the Life of the Clipper is selected by the Buyer and the Seller along with an expiration time and date for the Life of the Clipper. After a negotiation for a starting price for the clipper and a clip limit amount, the Buyer lists a resident order of a clipper for the referenced underlying financial instrument along with the clip limit, the expiration, a specified number of underlying units or a notional amount of underlying value.

The method and system of the present invention are being described relative to a computer processor or system, which is a preferred embodiment. The method and system may also function without a computer processor or system, by verbal or written communication, or telecommunications.

The Seller in a subsequent step indicates his intention to match at least one unit of the specified number of underlying units from the buying counterparty. The electronic facility, on the trading platform associates or matches the lowest number of units among those listed by the Buyer or indicated by the Seller. The Buyer, Seller, or third party then specify an observed price for the reference underlying financial instrument at the time of expiration and is subtracted the starting price for the clipper from the observed price at expiration in order to obtain or calculate an original difference.

An absolute value of the original difference is then determined by the parties or the third party and saved as a sign of the original difference. The Buyer, Seller or third party then determines whether the absolute value of the original difference exceeds the clip limit amount for the clipper. In the positive, an interim settlement value is established equal to the absolute value of the clip limit. In the negative, an interim settlement value equal to the absolute value of the original is established. Finally, the Buyer, Seller, or third party reattatch the saved sign of the original difference to the interim settlement value, to obtain the final settlement value and the paid if the sign is negative, or otherwise the Seller must pay the Buyer the final settlement value upon a positive value of the sign.

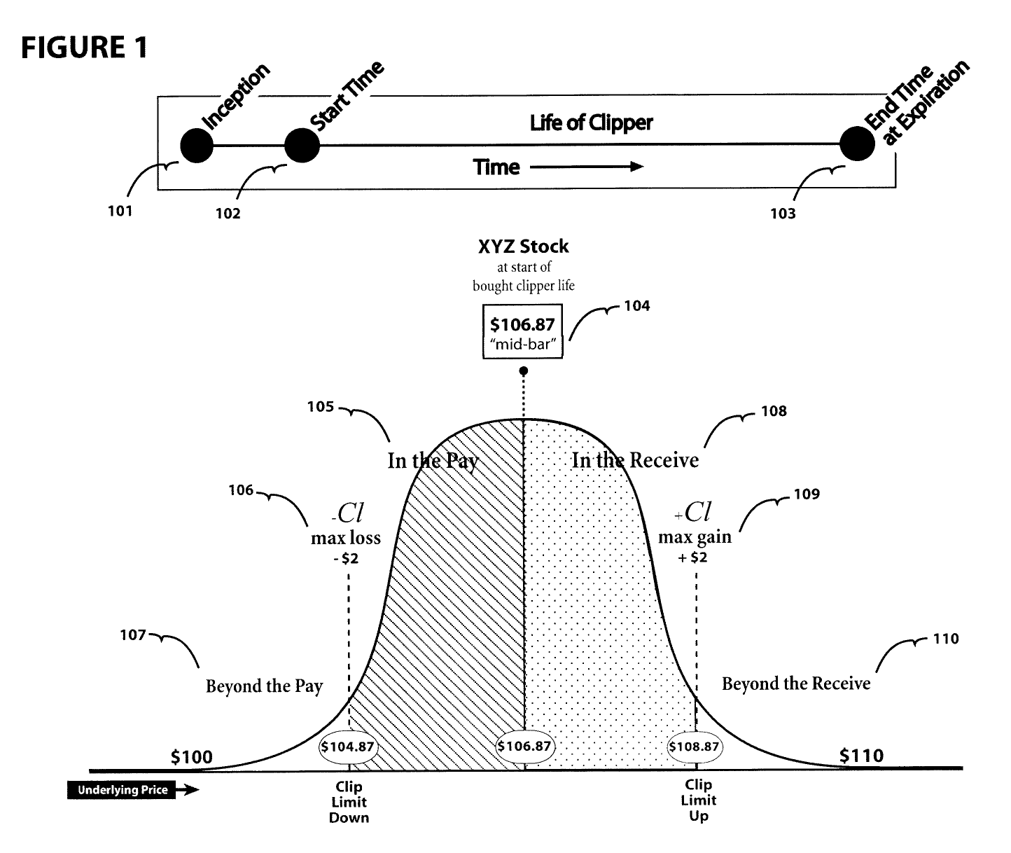

In FIG. 1, the Life of the Clipper starts with Inception, which is the time at which the Buyer and Seller agree to specify the clipper, 101. The Inception may take place at any time before or at the same time as the Start Time of the Clipper, 102. The Life of the Clipper exists between the Start Time and the End Time of the Clipper. As defined herein, the “life” of a clipper is the length of time immediately following the start time of the clipper, whose end time is the expiration of the clipper. A specification of a clipper trade can be agreed to by the two counterparties at any time before the designated start time of the clipper. Such an agreement brings the clipper into existence, which is called the “inception” of the clipper.

The End Time at Expiration is the time and date during which the price of the referenced underlying is observed for the purposes of settlement, 103. The potential probability distribution of the referenced underlying XYZ Stock at the time of expiration is shown below the $106.87 “mid-bar” price that is used as a Starting Price of the clipper, 104. As defined herein, the “mid-bar” of a clipper is the Starting Price of the clipper that is negotiated by the Buyer and the Seller of the clipper at the inception of the trade. The Life of the Clipper may be long enough where someone who is experienced in capital markets trading would incorporate “risk free rate drift” into the calculation of such a Starting Price, so that any accrued value in the underlying over the Life of the Clipper can be incorporated.

The mid-bar is a dividing line in the payoff function of the clipper for the Buyer and Seller. The Bell Curve is from the perspective of the Buyer. The area of the probability distribution to the left of the mid-bar is called an In The Pay region, 105. This means that the Buyer faces the prospect of paying the Seller for the clipper outcome, if the referenced underlying is observed to be between $104.87 and $106.87 at expiration. For the boundaries of the In The Pay region, the Clip Limit Down for the observed underlying price is established at $104.87, and the Mid-Bar is at $106.87. If the underlying falls into the In The Pay region, the Buyer must pay some calculated amount to the Seller.

The least amount of money that could be paid by the Buyer to the Seller as settlement for this clipper is $0.01, if the referenced underlying falls one penny below the mid-bar. The most amount of money that could be paid by the Buyer to the Seller as settlement for this clipper is $2.00, if the referenced underlying falls two dollars or more below the mid-bar, 106. This threshold of maximum loss is called the Clip Limit Down, at $104.87. If the referenced underlying price falls below the Clip Limit Down, the amount of money paid by the Buyer to the Seller as settlement is capped at $2. The region that lies to the left of the Clip Limit Down is called Beyond the Pay, 107. This region is where the Clip Limit protects the Buyer from losing any more money than $2.

The area of the probability distribution to the right of the mid-bar is called an In-The-Receive region, 108. This means that the Buyer faces the prospect of receiving money from the Seller for the clipper outcome, if the referenced underlying is observed to be between $106.87 and $108.87 at expiration. For the boundaries of the In-The-Receive region, the Clip Limit Up for the observed underlying price is established at $108.87, and the Mid-Bar is at $106.87. If the underlying falls into the In-The-Receive region, the Buyer must receive some calculated amount of money from the Seller.

The least amount of money that could be received by the Buyer from the Seller as settlement for this clipper is $0.01, if the referenced underlying rises one penny above the mid-bar. The most amount of money that could be received by the Buyer from the Seller as settlement for this clipper is $2.00, if the referenced underlying rises two dollars or more above the mid-bar, 109. This threshold of maximum gain is called the Clip Limit Up, at $108.87. If the referenced underlying price rises above the Clip Limit Up, the amount of money received by the Buyer from the Seller as settlement is capped at $2. The region that lies to the right of the Clip Limit Up is called Beyond the Receive, 110. This region is where the Clip Limit prevents the Buyer from gaining any more money than $2.

### Specification of a Clipper at Inception.

A speculative long Buyer may wish to purchase XYZ stock at $106.87 and hold that position for a time horizon of one week, in order to obtain a targeted return of $2, due to an expected appreciation of the stock to move from $106.87 to $108.87. If a speculative short Seller of XYZ stock at that time, with an identical time horizon of one week, and with an identical targeted return of $2, due to an expected depreciation of the stock to move from $106.87 to $104.87 could be found on an electronic trading facility, and then matched against the aforementioned speculative long Buyer, the two counterparties can jointly execute a new kind of derivative trade. This derivative trade is a $2 clipper on the $106.87 price of the underlying XYZ stock at time of inception, set to expire in 1 week.

The amount of $2 is a “clip limit” for the maximum upside and downside potential of the clipper tracking the underlying instrument. This “clip limit” represents a close approximation to the targeted return expected by both the long Buyer and the short Seller of the clipper at the time of inception. The long Buyer, of course, expects a $2 return resulting from the XYZ stock moving up from $106.87 to $108.87. The short Seller, of course, expects a $2 return resulting from the XYZ stock moving from $106.87 moving down to $104.87.

The simple specification of a Clipper is shown in table 1 below.

TABLE 1

| | A | B |
|---|---|---|
| 1 | Buyer | Aardvark |
| 2 | Seller | Beaver |
| 3 | Underlying | XYZ Stock |
| 4 | Start-Time | Fri Sep 7 06 4:00 pm ET |
| 5 | Start Price | 106.87 |
| 6 | Clip Limit | 2 |
| 7 | Clip Limit Up | =(B5 + B6) |
| 8 | Clip Limit Down | =(B5 − B6) |
| 9 | Expiration | Fri Sep 14 06 4:00 pm ET |

### Specification of a Clipper at Inception.

In cell A1, a Buyer is listed. A Buyer of a clipper is a speculator who believes that the Underlying referenced in A3 will appreciate, that is, increase in price. In this example, the Buyer of the clipper is Aardvark, as found in cell B1, an alias of a professional trader. In cell A2, a Seller is listed. A Seller of a clipper is a speculator who believes that the Underlying referenced in A3 will depreciate, that is, decrease in price. In this example, the Seller of the clipper is Beaver, as found in cell B2, an alias of another professional trader. The Underlying as found in cell B3, is a specified stock, bond, currency, commodity, or some other financial instrument or economic event or index of indication whose value, price, or changing variable can be referenced and reported for the purpose of negotiating a start price for the clipper, and for the purpose of settling an end price for the clipper. The selected Underlying is XYZ Stock, as found in cell B3. The Start Time of the trade, as found in cell A4, is when the clipper begins to be effective, that is, the start of the Life of the Clipper. In this example, the Start Time is Friday, Sep. 7, 2006, 4:00 pm Eastern Standard Time, as found in cell B4.

The Start Price of the clipper, as found in cell A5, is the mid-bar of the clipper payoff function, that is, the point from which a clip limit amount is mapped equidistantly up and down to a Clip Limit Up and a Clip Limit Down. In this example, the Start Price of the clipper is negotiated to be at $106.87, as found in cell B5. This price could indeed be the coincidental price of XYZ stock at the time of the inception of the trade, which can take place any time before or exactly at the Start Time of the Life of the Clipper. That is, the time at which the clipper trade is agreed-to by the Buyer and Seller can conceivably take place before the actual Start Time of the Life of the Clipper.

Those experienced in capital markets know that underlying financial instruments are expected to experience, on average, something called “risk free rate” drift over a given time period. This drift is based on the fact that a financial instrument is expected to provide an overall rate of return that exceeds that of a risk free rate, which, in the United States, for a three-month period, and for many shorter periods, is considered to be a Treasury Bill rate. If the Treasury Bill rate at the time of negotiating the Start Price of the clipper is 5.5%, and the price of the underlying XYZ Stock is $106.87, the expected price of XYZ is expected to “drift” upwards by 5.5% annually, over the life of a clipper. Since the clipper is expected to last only 1 week, and 1 week is 1/52 of a year, we can approximate this risk free rate drift by multiplying $106.87*5.5% and then dividing this product by 52, which equals 11.3 cents. We round 11.3 cents to 11 cents, and add the 11 cents to the $106.87 stock to get $106.98. In most trading situations, the starting price of the XYZ Stock clipper will incorporate the additional 11 cents, in order to neutralize risk free rate drift between Buyer and Seller. But for purposes of simplicity and illustration, we will leave out the risk free rate drift from our calculations.

The Clip Limit of the clipper, as found in cell A6, is the maximum amount of underlying movement up or down that will be experienced by the clipper payoff function. In this example, the Clip Limit is $2, as found in cell B6. The Clip Limit Up of the clipper, as found in cell A7, is the maximum upside appreciation in the underlying that will be experienced by the clipper. The Clip Limit Up of the clipper is always computed to be the Start Price of the Clipper, plus the Clip Limit, as found in the formula=(B5+B6) in cell B7. In this example, The Clip Limit Up is equal to the Start Price of the Clipper, which is $106.87, plus the Clip Limit, which is $2. This Clip Limit Up of $108.87 is the price of the underlying stock XYZ that will result in every penny of the $2 in margins furnished by the Seller to be paid from the Seller to the Buyer. The Clip Limit Down of the clipper, as found in cell A8, is the maximum downside depreciation in the underlying that will be experienced by the clipper. The Clip Limit Down of the clipper is always computed to be the Start Price of the Clipper, minus the Clip Limit, as found in the formula=(B5−B6) in cell B8. In this example, The Clip Limit Down is equal to the Start Price of the Clipper, which is $106.87, minus the Clip Limit, which is $2. This Clip Limit Down of $104.87 is the price of the underlying stock XYZ that will result in every penny of the $2 in margins furnished by the Buyer to be paid from the Buyer to the Seller.

The Expiration of the clipper, as found in cell A9, is the end of the Life of the Clipper, and is when the value, price, or changing variable of the Underlying can be referenced and reported for the purpose of settling an end price for the clipper. In this example, the Expiration is Friday, Sep. 14, 2006, 4:00 pm Eastern Standard Time, as found in cell B9. At the time of Expiration, the price of XYZ Stock is observed, and used to settle the value of the clipper. The resulting specification of a clipper is shown below.

TABLE 2

| | A | B |
|---|---|---|
| 1 | Buyer | Aardvark |
| 2 | Seller | Beaver |
| 3 | Underlying | XYZ Stock |
| 4 | Start-Time | Fri Sep 7 06 4:00 pm ET |
| 5 | Start Price | 106.87 |
| 6 | Clip Limit | 2 |
| 7 | Clip Limit Up | 108.87 |
| 8 | Clip Limit Down | 104.87 |
| 9 | Expiration | Fri Sep 14 06 4:00 pm ET |

### Margining a Clipper at Inception.

A clearinghouse can act as a guarantor of clippers that are agreed to by market participants, without being concerned about the credit risks of counterparty default. This is facilitated by a clearinghouse acting as a collector of required margins from Buyer and Seller.

Counterparties can contribute “all-in” margins to a clearinghouse in amounts equal to the clip limit of a clipper, and ensure that they immune to the risk of a margin call on that exposure. That is because the maximum prospective loss that can possibly be experienced by Buyer or Seller due to market movements in the price of the underlying is defined to be capped to the amount of margins furnished, as established by the clip limit amount.

Thus the “all-in” margins of a clipper are initial margins that can never be subjected to a later margin call. Such “100% pre-paid margin” clippers are not vulnerable to any kind of variation margin or maintenance margin from any clearinghouse.

A clearinghouse can safely run a “debit card” environment for clippers in which there are no credit relationships, that is, no “loaning” or “borrowing” of cash to and from the clearinghouse to facilitate trades by market participants. Thus there is no potential for outstanding losses by market participants that could not be met by “all-in” margins already furnished to the clearinghouse.

The clipper margin in this example required from the Buyer named Aardvark is $2, and the margin required from the Seller named Beaver is $2. Both of these amounts of money are held by the clearinghouse at the inception of the clipper trade, to fund the payment of any clipper settlement amount up to $2 that is paid from the Loser to the Winner. Any margin that remains after the settlement amount is fully paid is released back to the respective counterparties.

The “all in” margin amounts for each counterparty are shown here as positive values, because the clipper's winner gets 100% of the “all in” margins released from the clearinghouse upon the settlement of the trade, alongside the exact amount of the gain from the clipper. The clipper's loser has 100% of the “all in” margins reduced by the exact amount of the loss on the clipper. Thus the Buyer All-In Margins, as found in cell A11, represent the maximum possible loss that the Buyer can experience on the trade. And the Seller All-In Margins, as found in cell A12, represent the maximum possible loss that the Seller can experience on the trade. The same amount of All-In Margins of both Buyer and Seller is identical to the Clip Limit amount of the clipper trade, as found in cell B6.

In this example, the Buyer All-In Margins in cell B11 is specified as −2.00, because it is identical to the negative of the Clip Limit in cell B6. In the same way, the Seller All-In Margins in cell B12 is specified as −2.00, because it too is identical to the negative of the Clip Limit in cell B6. This is represented in Table 3 below.

TABLE 3

| | A | B |
|---|---|---|
| 11 | Buyer All-In Margins | =−B6 |
| 12 | Seller All-In Margins | =−B6 |

### Settlement of a Clipper at Expiration.

For our example, at the time of expiration, the $2 clipper has a payoff function that calculates any upside price of the underlying XYZ stock from $106.88 to $108.87 as a profit that ranges from $0.01 to $2.00 for the long Buyer (which is a loss that ranges from $0.01 to $2.00 for the short Seller). Any upside price of the underlying XYZ stock that goes above $108.87, however, is contractually capped at a maximum $2.00 in profit for the long Buyer (and capped at a maximum $2.00 in loss for the short Seller).

At the time of expiration, the $2 clipper has a payoff function that calculates any downside price of the underlying XYZ stock from $106.86 to $104.87 as a profit that ranges from $0.01 to $2.00 for the short Seller, which is a loss that ranges from $0.01 to $2.00 for the long Buyer. Any downside price of the underlying XYZ stock that goes below $104.87, however, is contractually capped at a maximum $2.00 in profit for the short Seller, and capped at a maximum $2.00 in loss for the long Buyer.

Each of the counterparties to this $2 clipper example has furnished $2 in margins to a third party at the inception of the trade. The third party can be a clearinghouse. The short Seller furnishes margins to the third party of $2 for up to $2 in one's own prospective loss (a gain for the long Buyer) that may occur if XYZ stock goes up. The long Buyer furnishes margins to the third party of $2 for up to $2 in one's own prospective loss (a gain for the short Seller) that may occur if XYZ stock goes down.

A simple settlement of the Clipper is shown in Table 4 below.

TABLE 4
Settlement of a Clipper at expiration.

| | C | D |
|---|---|---|
| 1 | Start Price | =B5 |
| 2 | Clip Limit | =B6 |
| 3 | Observed Price of Underlying at | 104.22 |
| | Specified Expiration | |
| 4 | Original Difference Between | =D3 − D1 |
| | Two Prices | |
| 5 | Absolute Value of that Original | =ABS(D4) |
| | Difference | |
| 6 | Saved Sign of the Original | =IF(D5 = 0, 0, ABS(D4)/D4) |
| | Difference * 1 | |
| 7 | Does This Absolute Value Exceed | =IF(D5 > D2, “YES”, “NO”) |
| | the Clip Limit? | |
| 8 | Interim Settlement Value | =IF(D7 = “YES”, D2, D5) |
| 9 | Reattach the Saved Sign of the | =D8 * D6 |
| | Original Difference | |
| 10 | Final Settlement Value | =D9 |
| 11 | Buyer Receives (or Pays) | =D10 |
| 12 | Seller Receives (or Pays) | =−D10 |

The Start Price of the clipper is known from the specification, as originally found in cell B5, which is found here in cell D1. The Clip Limit of the clipper is also known from the specification, as originally found in cell B6, which is found here in cell D2.

The Observed Price of the Underlying at the time of Expiration depends on looking up the price of XYZ Stock at the time and date originally specified in cell B9 in the specification of the clipper. This value, for the purposes of this example, was observed to be 104.22, and is introduced into cell D3.

The settlement process then begins the calculation of the value of the clipper at expiration. The Original Difference Between Two Prices is calculated in cell D4 with the formula (D3−D1), which, in this example, yields a negative $2.65. The Absolute Value of That Original Difference is calculated in cell D5 by the formula (ABS)D4, which, in this example, yields $2.65, without any positive or negative sign attached.

The Saved Sign of the Original Difference*1 facilitates the retention of the sign of the previous calculation, as found in cell D6, with the formula IF(D5=0,0,ABS(D4)/D4) which yields for this example a figure of negative 1.

The question, “Does This Absolute Value Exceed the Clip Limit?,” facilitates the conditional determination as to whether the change in the underlying XYZ stock price was larger than $2. This conditional determination can be found in cell D7, with the logical formula IF(D5>D2,“YES”,“NO”). In this example, the answer is YES, because the $2.65 change in underlying price was indeed greater than $2.

An Interim Settlement Value can be calculated by retaining the Original Difference if it is equal to or less than the Clip Limit, or else substituting the Clip Limit itself for the Original Difference if it is greater than the Clip Limit, as found in cell D8 with the formula IF(D7=“YES”,D2,D5). If so, the Clip Limit value is used, instead of the Original Difference value. This line of code is the key calculation of the clipper financial instrument, because it forces the clipper value to remain at or within the bounds of the Clip Limit, even when the price of the underlying is actually observed to be far outside the bounds of the Clip Limit. For this example, the Interim Settlement Value is $2.

With the Interim Settlement Value settled, the next step is to Reattach the Saved Sign of the Original Difference to the Interim Settlement Value, as found in cell D9, with the formula D8*D6. This is also the Final Settlement Value as found in cell D10, which in this example is $2.

The settlement process may be performed by the Buyer, the Seller or any third party with the required specifications. A clearinghouse may serve as a settlement agent for the clipper if it is also holding margins to guarantee performance of the clipper trade to the Buyer and the Seller.

The Buyer of this clipper receives (or pays) the amount of money shown in cell D12, which is always identical to that of cell D10, which in this example is a negative $2. The Seller of this clipper receives (or pays) the amount of money shown in cell D13, which in this example is a positive $2, essentially, forcing the Buyer to lose all of the money placed in margins at the inception of the trade.

### Release of Margins After Settlement.

The money shown in D12 would be multiplied by any number of clipper units traded. If, for example, the number of clipper units were to be 50, the settlement of the trade would be $2 multiplied by 50, to be exchanged from Buyer to Seller. Of course, the “all-in” margins held at the inception of the trade would be as large as the number of clipper lots traded, so both Buyer and Seller in this extended example would be required to have a total amount of 50 units of $2 margin kept at a clearinghouse to facilitate the trade in the first place.

TABLE 5

| | C | D |
|---|---|---|
| 15 | Buyer's Received Release of | =MIN(−B11, −B11 + D11) |
| | All-In Margins | |
| 16 | Seller's Received Release of | =MIN(−B12, −B12 + D12) |
| | All-In Margins | |

One can determine the impact of the settlement of the clipper trade on the “all in” margins of the Buyer by viewing the Buyer's Received Release of All-In Margins, found in cell D15, whose formula=MIN(−B11,−B11+D11) looks for the minimum value among two values: the negative of the margins of the Buyer, or the negative of the margins of the Buyer plus the settlement value of the clipper for the Buyer. In this example the resulting value is $0. None of the “all in” margins of the Buyer are to be released back to the Buyer.

Next, the settlement value of the clipper is combined with the release of margins for each counterparty, as paid by the clearinghouse as seen in Table 6.

TABLE 6

| | C | D |
|---|---|---|
| 18 | Buyer Collects From | =MAX(0, D15) + MAX(0, D11) |
| | Clearinghouse | |
| 19 | Seller Collects From | =MAX(0, D16) + MAX(0, D12) |
| | Clearinghouse | |

Any of the positive outcomes from cells D11 and D15 are combined by the clearinghouse and provided to the Buyer, as found in cell D18, whose formula=MAX(0,D15)+MAX(0,D11) provides for such a combination. In this example, $0+$0 are provided to the Seller.

Any of the positive outcomes from cells D12 and D16 are combined by the clearinghouse and provided to the Seller, as found in cell D19, whose formula=MAX(0,D16)+MAX(0,D12) provides for such a combination. In this example, $2+$2 are provided to the Seller.

### Example of Capital Relief of a Clipper when Compared to Underlying Stock.

Since both counterparties were capped in their maximum prospective loss at $2, there was no need to tie up $106.87 or $53.44 for the period of a week in order to obtain a $2 targeted return on the relative movement of XYZ stock. Each counterparty needed only to tie up $2 in margin to obtain the expected $2 in targeted return.

To summarize: the long trader Aardvark, spending only $2 in margins and paying no additional “brokerage rate” interest under Regulation T to save money, obtained a prospective $2 in “hard return” for a relative 100% return, alongside the return of the $2 in margins, which appears to be a much better return relative to tied-up capital than the first two examples.

The remaining $104.87 that was not required to be spent to pay for the $2 appreciation in the $106.87 stock can be deployed usefully elsewhere, perhaps to be invested in Treasury Bills, or in other financial investments.

The pick-up of additional risk-free income from Treasury Bills, added to the prospect of targeted return, can make clippers a popular alternative to investing in an underlying.

### Capital Efficiency of a Clipper is Enhanced after Utilizing Freed-Up Capital.

For the speculative trader who has a “time horizon” of one week and “targeted return” of $2, a Clipper position requiring margins of $2 to get $2 in expected return is very capital efficient, especially when compared to a stock position that requiring $100 or $50. Indeed, the known “targeted return” of the speculator can be used to establish a desired “clip limit” for the Clipper itself. A speculator with a “targeted return” of $1, for example, may decide to undertake a $1 Clipper rather than a $2 Clipper, if a $1 Clipper is readily available from a counterparty.

Usually the capital efficiency of a financial instrument is judged by how much money is required to be tied-up in margins or collaterals over the life of a trade in order to obtain a certain amount of expected risk or expected return. If a trader normally needs to tie up $50 with an Underlying PQR financial instrument for 1 year to obtain $3.50 in expected return, the trader is calculated to have an expected relative return of 7%.

But if a trader needs to tie up only $3.50 with a Clipper for 1 year to obtain that same $3.50 in expected return, the capital efficiency of the Clipper allows the trader to have an expected relative return of 100%, and the trader can divert the remaining $46.50 in leftover capital into other investments. Other investments are available to the trader for the leftover capital. If the annual Treasury Rate is 5.5%, and Treasury investments are believed to be risk-free, the improvement in capital efficiency for the original $50 can be said to be improved by adding the first amount of $3.50 (in hard return for the tie up of $3.50 for the Clipper), to the second amount of $2.56 (a risk-free hard return in Treasury Rate for the tie up of the leftover $46.50), equaling $6.06 overall for the total tie-up of $50. This overall advantage in capital efficiency, where 12.12% in relative return of the Clipper plus Treasuries well exceeds that of 7% in the standalone Underlying, is quite an improvement.

When any two counterparties speculate on the future price of a referenced Underlying, one expecting the price to go up, and the other expecting the price to go down, with both sharing the same time horizon to hold the position, and sharing a common targeted return, a Clipper can markedly reduce the amount of capital sunk into their respective positions, if a clip limit is “right-sized,” that is, specified to be just large enough to incorporate the amount of such a targeted return.

In most situations, a Clipper can provide to a winning counterparty the same targeted returns (or the same lesser amount otherwise resulting), as would occur in a face-value investment in the Underlying, but with much greater capital efficiency, because a Clipper would require less in invested capital.

Further, a Clipper can provide counterparties with less portfolio vulnerability to volatility when compared to a face-value investment in an Underlying, because extreme changes in an Underlying price are not restricted to the amount specified in the “clip limit,” while such changes in the value of the Clipper are very much so restricted.

For example, a money manager may be concerned about overall portfolio volatility, because the portfolio may be comprised of only Underlyings. If the money manager were to substitute Clippers with restrictive clip limits for each of those individual Underlyings, the portfolio volatility will go down significantly. This is because each Clipper substituting for each individual Underlying will prevent extreme changes in that Underlying that move beyond either clip limit from contributing excess volatility to the overall portfolio volatility.

Indeed, the clip limits themselves serve as a kind of user-setting of acceptable volatility to traders, because swings of profits and losses on individual investments are guaranteed to be reduced to acceptable levels. By capping all gains and losses on all investments to an acceptable level, a trader can decide to take the lesser of the absolute value of an acceptable stop loss, versus the absolute value of the targeted return, and use that lesser value as the clip limit for the Clipper trade.

Clippers provide a safe and rigid cap on losses to investors. This is because the clip limit amount establishes a stop loss limit that is guaranteed on any Clipper trade, regardless of the available levels of liquidity in the Underlying market or Clipper market after the Clipper has been incepted. There is no need to “hedge out” of the Clipper, or to “close out” or “reverse” a Clipper position in an attempt to prevent runaway losses.

The method and system of the present invention provide a way for money managers to get safe, added, risk-free rate returns on top of their targeted returns by using clippers. This is due to the enormous amount of money that is freed-up after clipper margins are paid. If a money manager is accustomed to spending $106.87 for a $2 return on XYZ stock, and now is spending $2 to get a $2 return on XYZ stock, $104.87 in leftover capital can be safely deployed to get a risk-free rate.

A step-by-step explanation of the economic rationale behind the construction of a Clipper is hereby provided as an aid to professionals trained in the art of capital markets trading.

A Clipper requires exactly one unique trader to act in the role of a Buyer, and exactly one unique trader to act in the role of a Seller. A Clipper is not a derivatives combination, but a single financial instrument, requiring exactly two counterparties, Buyer and Seller. For certain derivatives combinations, in contrast, there may be as few in number as two counterparties, or, as many in number as one plus the number of individual derivatives comprising the derivatives combination itself. Under the calculation of the unitary payoff function of the Clipper at settlement, a Buyer will gain from any upside appreciation of a selected Underlying, and a Seller will gain from any downside appreciation of that same selected Underlying. Thus a Buyer will have a verb associated with a Clipper trade that will indicate “buy” and the Seller will have a verb associated with a Clipper trade that will indicate “sell.”

The Buyer and Seller must also co-select the same referenced Underlying for the Clipper. A referenced Underlying can be co-selected by the two counterparties by coincidence, that is, by selecting the Underlying at the same “place” at the same time, without any pre-mediated coordination or collusion. A “place” may be the virtual space of a computerized environment, like at the bulletin board or quotation display of an electronic trade facility, where Buyers and Sellers congregate by means of telecommunication networks to negotiate, offer, bid, or request to make Clipper trades. An Underlying is a specified stock, bond, currency, commodity, or some other financial instrument or economic event or index of indication whose value, price, or changing variable can be referenced and reported for the purpose of negotiating a Start Price for the Clipper, and for the purpose of settling an end price for the Clipper.

The Buyer and Seller must also select a starting time and date, and ending time and date, for the Life of the Clipper. A Clipper contract expires at the ending time and date, and is soon thereafter settled to an observed price of the Underlying. Between the starting time and date and the ending time and date is the “life” of the Clipper, during which the value of the Clipper can fluctuate and change.

The Buyer and Seller must also select a clip limit amount that will be pegged to a Start Price for the Clipper. The clip limit amount is a specified amount of movement in the Underlying from the Start Price of the Clipper that will be fully reflected in the unitary payoff function of the Clipper. This specified amount can be described in denominated components of the value of the Underlying. For example, a clip limit can be described as a certain number of dollars of movement in an Underlying whose value is also denominated in dollars. Any amount of movement in an Underlying that would go beyond the clip limit amount would result in the clip limit amount itself being reflected in the unitary payoff function of the Clipper.

The Buyer and Seller must also select a starting price for the Clipper. This starting price will serve as an amount that will be subtracted from the observed price of the Underlying at expiration, as part of the determination of the settlement value of the Clipper. The starting price of the Clipper can be determined before the start of the Life of the Clipper, but not before the inception of the trade, because the terms of the Clipper trade are not agreed upon between Buyer and Seller until inception. The Start Price of the Clipper can reference the Underlying price at the time of inception, at the time of the start date and time of the Clipper life, or some other negotiated basis for establishing the amount that will be subtracted from the observed price at the time of expiration.

If the Buyer and Seller wish to trade multiple units of Clippers referencing an Underlying, the number of units to be traded can also be agreed upon by the two counterparties. In such a case, the value of the payoff function of the Clipper at settlement is simply multiplied by the agreed number of units to settle the overall trade.

The clipper requires the establishment of a clip limit, expiration, and specified underlying, but otherwise is disarmingly easy to understand, specify, execute, value at expiry, and settle.

Clippers also are easily conformable to existing industry practice. Clippers can be used as complete substitutes for underlying financial instruments, without requiring any change in investment execution, strategy, tactics, style, or underlying portfolio philosophy. Clippers do require money managers to be disciplined in their specifications of time horizon and targeted return, but otherwise will facilitate almost any kind of strategy that can be practiced in the investment world.

Clippers also have favorable properties when compared to options. First, clippers do not require “rigid” pre-defined strike prices to be specified by Buyers and Sellers. In other words, clippers with $1.23 clip limits on KLM stock expiring in the next three days can be easily executed at a start price of $87.67, without requiring Buyers and Sellers to wait until KLM reaches a whole $87.00 or $88.00 to facilitate a $1.00 clipper where the Clip Limit Up and Clip Limit Down is an even dollar number.

Clippers are also advantageous compared to options because they are margined instruments, and not premium instruments. For example, the Buyer of a $5 clipper on FGH stock with a start price of $80 will lose only $0.01 if FGH stock is observed at $79.99 at expiration. If an option investor were to purchase a $6 call on FGH stock with a strike price of $80 (which would be a more expensive premium than the $5 in margins paid by the clipper investor) the option would expire at $79.99, out of the money, and all of the $6 in premium would be lost.

Clippers are also advantageous in the sense that many investors will consider clippers safe to carry to expiration, without requiring hedging. This is because clippers can never experience “extreme movement” risks like underlyings can. As a result, clippers will frequently limit the runaway losses of an exposure, to the point where offsetting a clipper with a future, option, or underlying as a hedge will frequently be a futile endeavor. In most circumstances, a clipper's clip limit will provide most of the loss protections that can be afforded by a hedging instrument. In fact, offsetting a clipper with a hedging future, option, or underlying will frequently be counterproductive, because the expense of margining that hedging instrument can be very high when compared to the clipper, and the risk management expertise required to manage the open tail risk of that hedging instrument can be very demanding. Clippers can be cheaper than other financial instruments to carry to term, but that means that most other instruments are relatively expensive to use as a hedge against losses in clippers.

### Summary of Unique Clipper Properties

For decades, practitioners in the capital markets have traded derivatives long existing in the public domain. These derivatives have been combined in myriad and sundry ways to create new financial trading strategies that may coincidentally share one or two properties with clippers, while not sharing all of the others. Some of these are customized in structure, and, due to the artisan nature of such embodiments, they cannot be seen as a specification of a “standard manufacture” of a novel, non-obvious, and useful financial instrument that would be a protectable invention. However, one trained in the prior art can readily distinguish between the unique properties of the “standard manufacture” of a clipper, as enumerated below, from those of any other derivative instrument or stratagem that are protectable, or in the public domain. A standard manufacture of a financial instrument is a means of producing, from a template of common terms, conditions, and procedures, an instance of a payoff function between counterparties whose variables guarantee unique capital, risk, and return properties to those counterparties. For example, the standard manufacture of a clipper should produce, from a common template, an instance of a payoff function with a collection of capital, risk, and return properties that are unique to the clipper, whose collection are not discoverable in the standard manufacture of instruments that are protectable, or in the public domain.

The first unique clipper property is the unitary payoff function. The payoff function of a clipper is unitary because it is “one of a piece,” that is, an integral part of the clipper definition itself. A clipper has a single, diagonal, continuous linear payoff function bracketed by a constant threshold of maximum gain and loss placed equidistantly above and below the start price of the clipper, whose equidistance is specified solely by the clip limit amount. When a liquid cash market for the current underlying price can be readily referenced, the start price of the clipper is set at or very near the expected future underlying price, which is typically the current underlying price with slight upside appreciation due to risk free rate drift. Indeed, the Start Price, Clip Limit Up, and Clip Limit Down of a clipper are dependent on two independent variables that are determined by the two counterparties: 1) the expected future underlying price and 2) the clip limit amount. Thus one trained in the art would easily acknowledge that the clipper's Start Price, Clip Limit Up, and Clip Limit Down do not in any way resemble three independently-selected strike prices whose attached options can theoretically be subsequently detached and traded out away from the clipper, without destroying essential clipper properties in the “leftover” clipper. One can determine the unitary payoff function by re-examining the specification of a clipper at inception. A Start Price and Clip Limit is all that is needed to establish a Clip Limit Up and a Clip Limit Down for a clipper financial instrument, as shown below.

| | A | B |
|---|---|---|
| 5 | Start Price | 106.87 |
| 6 | Clip Limit | 2 |
| 7 | Clip Limit Up | =(B5 + B6) |
| 8 | Clip Limit Down | =(B5 − B6) |

The second unique clipper property is the absence of any tailed risk that could potentially require variation margin calls at a clearinghouse. If the initial margin amount are identical to the clip limit amount of the trade, such initial margins would be “all-in” margins, where the maximum loss of the trade is already pre-funded at the inception, or effective time, of the trade. This obviates the need for further margin calls. Indeed, a superior credit counterparty or clearinghouse can conceivably run a “debit card” environment when acting as a central counterparty between opposing Buyers and Sellers of clippers, and safely deduct “all-in” margins from their available balances on deposit, without undertaking any credit risk of subsequent default. For tailed risk instruments, like underlyings, forwards/futures, options, or swaps, such paired field parameters as “initial margins/collateral” alongside “variation margins/collateral” are prudently required to facilitate trades among counterparties. For clippers, however, these field parameters can be summarily replaced by a single ““all-in” margins/collaterals” field parameters requirement. One can determine the absence of any tailed risk by re-examining the settlement of a clipper after expiration. Indeed, by typing in various values in cell D3 for the Observed Price of Underlying at Specified Expiration that lie below 104.87, between 104.87 and 106.87, between 106.87 and 108.87, and above 108.87, one readily determines that the Buyer and Seller cannot gain or lose more than 2 dollars, as found in cells D11 and D12. Because the maximum gain and loss is capped at 2 dollars, clippers have no tail risk.

### Settlement of a Clipper at Expiration.

| | C | D |
|---|---|---|
| 1 | Start Price | =B5 |
| 2 | Clip Limit | =B6 |
| 3 | Observed Price of Underlying at | 104.22 |
| | Specified Expiration | |
| 4 | Original Difference Between | =D3 − D1 |
| | Two Prices | |
| 5 | Absolute Value of that Original | =ABS(D4) |
| | Difference | |
| 6 | Saved Sign of the Original | =IF(D5 = 0, 0, ABS(D4)/D4) |
| | Difference * 1 | |
| 7 | Does This Absolute Value Exceed | =IF(D5 > D2, “YES”, “NO”) |
| | the Clip Limit? | |
| 8 | Interim Settlement Value | =IF(D7 = “YES”, D2, D5) |
| 9 | Reattach the Saved Sign of | =D8 * D6 |
| | the Original Difference | |
| 10 | Final Settlement Value | =D9 |
| 11 | Buyer Receives (or Pays) | =D10 |
| 12 | Seller Receives (or Pays) | =−D10 |

The third unique clipper property is that the mirrored finite amount of “all-in” margin that would be prudently required by a clearinghouse with no credit relationship with either counterparty (in other words, in a “debit card” environment) will be the same for both counterparties and also pre-specified to be equal to the clip limit amounts placed equidistantly from the start price of the clipper. This “mirroring” property of finite margins can only be possible if the clipper is treated as a “clipped anticipation of subsequent movement of the underlying instrument from the start price until the end price at expiry” derivative financial instrument, where a clip limit amount has been identified as the sole determinant of “all-in” margins in the first place. Such a basis of margin determination is not found in the prior art literature for forwards/futures, options, and swaps, and other “tailed” risk instruments. Instead, these “tailed” risk instruments are margined by clearinghouses according to considerations of measured statistical standard deviations or volatility, skewness, kurtosis, and other measurements of movement uncertainty in the referenced underlying. Indeed, as of Aug. 23, 2007, the prior art of clearinghouse margining used a financial benchmark called “Value at Risk” of projected loss, or a SPAN stress scenarios of loss, to evaluate the economic costs of tailed risks and thereby determine margin/collateral requirements for market participants. In contrast, with clippers, a clearinghouse with a “debit card” environment can safely ensure solvency for all clipper trades, by ignoring such statistical uncertainties measured by a “Value at Risk” or SPAN stress projection of loss, and simply require “all-in” margins for clippers to be equal to the clip limit amounts specified by the trades. The clip limit amounts specified by the trades are often cheaper than what would be required by a “Value at Risk” or SPAN stress measurement of loss for a tailed risk instrument. (This is because the targeted return that is “sizing” the clip limit for a clipper is almost always smaller than the margins that would be required for the same targeted return on a tailed risk exposure.) The mirrored finite amount of “all-in” margin thus represents a cheaper capital requirement for undertaking a targeted return, which for a clipper, is defined to be equal to a maximum amount of potential loss. One can determine that the All-In Margins are indeed defined to be equal to the Clip Limit of the specified clipper, by comparing the amount in cell B6 representing the Clip Limit Amount, with the Buyer All-In Margins and Seller All-In Margins in cells B11 and B12, as shown below.

| | A | B |
|---|---|---|
| 6 | Clip Limit | 2 |

| | A | B |
|---|---|---|
| 11 | Buyer All-In Margins | =−B6 |
| 12 | Seller All-In Margins | =−B6 |

One can also determine that the All-In Margins pre-provided by each counterparty are indeed defined to be adequate to the prudent requirements of a “debit card” clearinghouse to remain solvent, by typing in various values in cell D3 for the Observed Price of Underlying at Specified Expiration that lie below 104.87, between 104.87 and 106.87, between 106.87 and 108.87 and above 108.87. After some time, one readily determines that the Buyer and Seller cannot gain or lose more than 2 dollars, as found in cells D11 and D12. This means that the Buyer's and Seller's respective Release of All-In Margins cannot fall below zero, as shown below.

| | C | D |
|---|---|---|
| 15 | Buyer's Received Release of | =MIN(−B11, −B11 + D11) |
| | All-In Margins | |
| 16 | Seller's Received Release of | =MIN(−B12, −B12 + D12) |
| | All-In Margins | |

At a clearinghouse, the relationship of required Initial Margin and Variation Margin to the “standard manufacture” of a long or short position in a tailed risk instrument like an underlying, forward/future, option, or swap is based on the expected “Value at Risk” or SPAN stress measurement of loss. It is impossible for a clearinghouse to require only a finite pre-specified amount of Initial Margin as All-In Margin at the inception of a tailed risk instrument trade, and not avail itself later of a Variation Margin call if the solvency of the trade is suddenly at risk. In contrast, the equivalency of All-In Margins with the Clip Limit Amount is a unique property of the “standard manufacture” of a clipper. Such All-In Margins guarantee capital adequacy to the clearinghouse for clipper trades in all market circumstances.

The fourth unique clipper property is the absence of a required field parameter for premiums. A clipper never allows any net premium to be paid or received between counterparties. In fact, a clipper has no requirement to include a field parameter that would even indicate an amount of net premium paid or received between counterparties. Clippers do not require a parameter to be established for premium amounts, but such a parameter is always required to be established for option strategies, even when the net premium amount turns out to be zero. In an option strategy, a field parameter is typically established in a Trade Specification Sheet or Entry Form (for example, a Field titled with the word “Premium”) to show that there is high likelihood of a net amount of premium paid or received between counterparties. In certain rare circumstances, when fortuitous and unlikely alignments of strike prices and offsetting premium amounts are discovered, an options strategy may result in a net premium of zero amount of money paid or received between counterparties, but such an options strategy would still require a field parameter, with an amount of net premium to be populated with the numeral zero. In every other case where such fortuitous nettings of option premiums result in smallish amounts to be paid or received between counterparties, the prior art still requires that the smallish amount be recognized. In other words, the prior art does not treat such nettings of option combinations as guaranteed in all cases to amount to zero, or alternatively guaranteed in all cases to amount to nil, that is, an amount that can be unaccounted for between counterparties over an arbitrarily large number of transactions without having a potentially measurable effect on a counterparty's cumulative profit and loss. The presence of a field parameter for a netted premium is recognized by the prior art to be a required element of any “standard manufacture” of an option or option strategy. In contrast, the absence of a parameter for a netted premium is a unique property of the “standard manufacture” of a clipper.

The fifth clipper property is the absence of a required field parameter for a specifying strike prices. A clipper is neither a “package” of options, nor a convenient marriage of options with a forward or future. A clipper does not have any provision to specify strike prices where option or option-like payoffs would need to be situated. Indeed, on an options exchange, standardized puts and calls are listed under a common, rigid specification of strike prices (for example, prices pegged to the nearest dollar, quarter, dime, or nickel) so as to provide easy transferability between purchasers and writers of those options over the life of the standardized contract. But even the most “flexible” specification of a customized option, even one for a customized strike price pegged to a specified penny, whether listed on exchange, or negotiated over-the-counter, requires a field parameter called “Strike Price” to specify that strike price, which is the beginning point for the payment function of the option. There is no such specified beginning point for a payment function of an option inside the payment function of the clipper. In summary, the presence of a field parameter for a strike price is an intrinsic requirement for any “standard manufacture” of an option. In contrast, the absence of a parameter for a strike price is a unique property of the “standard manufacture” of a clipper.

The sixth unique clipper property is that a clipper is an extremely useful speculation instrument when referencing a tailed risk underlying, but is not a reliable continuous hedge against a held position in such an underlying risk. That is because the clipper has a single, diagonal, continuous linear payoff function book-ended by a constant threshold of maximum gain and loss placed equidistantly above and below the start price, whose equidistance is specified solely by the clip limit amount. Certainly, a clipper with an arbitrarily small clip limit to sell, with a start price at or near the current underlying price, can theoretically be created to hedge the gains or losses of an existing long position in an underlying, but such a hedge will be effective only if the future underlying price were guaranteed to remain positioned between the Clip Limit Up and Clip Limit Down of the clipper, that is, strictly within the regions of In the Pay and In the Receive. Such a clipper would not be an effective hedge if the future underlying price were to drift beyond the regions of In the Pay and In the Receive, that is, Beyond the Pay and Beyond the Receive.

A hedge that does not effectively offset all of the outcomes of a referenced risk is said to suffer from “basis risk.” The degree to which a hedging clipper suffers from basis risk, may be roughly calculated by undertaking the following steps. Step One, determine the size of an adverse movement in the underlying that would represent an expected maximum loss. Step Two, determine the confidence interval of such an adverse movement. Step Three, determine the size of the clip limit amount of hedging clipper. Step Four, determine the confidence interval of an adverse movement equal to the clip limit amount of the hedging clipper, as found at the underlying price representing the closest of the Clip Limit Up or Clip Limit Down. Step Five, subtract the result of Step Three from that of Step One to obtain a remaining range of underlying outcomes whose contribution to expected maximum loss remains unhedged by the clipper. Step Six, subtract the result of Step Four from that of Step Two to obtain a remaining probability that the underlying will lie within that remaining range at the expiration of the hedging clipper. Step Seven, multiply the results of Step Five to those Step Six to obtain an expected amount of loss due to the basis risk of the hedging clipper, on a per underlying unit basis.

A simple Excel spreadsheet example illustrates the basis risk of a hedging clipper against the underlying as outlined by the previous seven steps. We first establish by statistical analysis the size and confidence interval for the expected maximum loss of PQR Underlying as a long or short position to be $30 at the 95% confidence interval, a typical confidence interval for measuring Value at Risk. We insert these numbers into the respective cells L2 and L3, as shown below. We also establish by statistical analysis the size and confidence interval for the expected maximum loss of a clipper referencing that underlying to be $10 at the 65% confidence interval, as if that clipper had the same direction of long or short as that underlying (even though the clipper, when placed as a hedge, will actually reverse the direction of the underlying). We insert these numbers into the respective cells L4 and L5, as shown below. We now establish the size and confidence interval of the remaining range, as the difference between those of the expected maximum loss of PQR and those of the clipper, as calculated by the formulas in cells L6 and L7. We find in our numeric versions of those cell calculations, the amounts of $20 and 30%. When the multiply these two cells of L6 and L7 together, and ensure that an absolute value is associated with the outcome, as found in cell L8, the expected basis risk between the hedging clipper and the expected maximum loss is a loss of $6.

| | J | K | L |
|---|---|---|---|
| 1 | For Adverse Movement . . . | PQR Underlying | |
| 2 | Expected Maximum Loss | Size | 30 |
| 3 | | Confidence Interval | 0.95 |
| 4 | Clip Limit | Size | 10 |
| 5 | | Confidence Interval | 0.65 |
| 6 | Remaining Range | Size | =L2-L4 |
| 7 | | Confidence Interval | =L3-L5 |
| 8 | Value of Basis Risk | | =ABS(L6 * L7) |

| | J | K | L |
|---|---|---|---|
| 6 | Remaining Range | Size | =20 |
| 7 | | Confidence Interval | =.30 |
| 8 | Value of Basis Risk | | =6 |

The effectiveness of a clipper as a potential hedge for underlying tailed risks is directly related to the size of the clip limit. A clipper with a theoretical range of clip limit that is infinite, or, very large, but restricted only to the maximum range of the underlying, will provide a long, extended, continuous hedge on that underlying, with near-zero basis risk. On the other hand, a clipper with a range of clip limit that is infinitesimal, or very small, will provide a short, interrupted, discontinuous hedge on that underlying, with near-complete basis risk.

Indeed the capital efficiency of the clipper as a hedge on an underlying, is inversely proportional to the capital efficiency of the clipper as a speculative instrument acting as a substitute for direct speculation in that underlying. A clipper with a large clip limit, lengthened to fit a maximum prospective amount of acceptable loss in an underlying, can provide a great deal of hedging coverage over a wide range of prospective outcomes for that underlying. But a clipper with such a large clip limit would provide very little additional capital efficiency if it were acting as a standalone speculation investment, wholly substituting for a direct speculation in that underlying. Alternatively, a clipper with a small clip limit, foreshortened to fit a prospective amount of expected return in an underlying, can provide additional capital efficiency as a standalone speculation investment wholly substituting for a direct speculation in that underlying, but with very little hedging coverage, over a narrow range of prospective outcomes for that underlying.

The seventh unique clipper property is that a clipper is an extremely useful speculation instrument when referencing a tailed risk underlying, that does not require further hedging. That is because the clipper has a single, diagonal, continuous linear payoff function book-ended by a constant threshold of maximum gain and loss placed equidistantly above and below the start price, whose equidistance is specified solely by the clip limit amount. A clip limit amount can be rightsized to fit a targeted return, but it can alternatively be rightsized to fit a maximum acceptable loss level to the speculative investor. This is usually coincident with a price level, for which, upon penetration, a “stop-loss” order would be submitted, to close out the speculative position.

In our earlier example, the amount of $2 is a “clip limit” for the maximum upside and downside potential of the clipper tracking the underlying instrument. This “clip limit” can represent a close approximation to the targeted return expected by both the long Buyer and the short Seller of the clipper at the time of inception. But the long Buyer may also be concerned about a maximum acceptable loss amount that may be suffered in this trade before a prospective threat to solvency. This amount might be independently calculated to be $1.50, which would be a loss occurring from the XYZ stock moving down from $106.87 to $105.37. The simple specification of rightsizing a clip limit, to fit the minimum of the absolute value of the targeted return, and of the absolute value of the maximum acceptable loss amount, can be displayed on an Excel spreadsheet, as shown below.

### Specification of a Clip Limit Amount.

| | N | O |
|---|---|---|
| 1 | Targeted Return | 2 |
| 2 | Maximum Acceptable Loss Amount | −1.50 |
| 3 | Clip Limit Amount | =MIN((ABS(O1, (ABS(O2)) |

The targeted return is shown in cell O1, which is $2, but the maximum acceptable loss amount is shown in cell O2, which is $1.50. The clip limit amount is pegged to the minimum function of the absolute values of the two values, which here is equal to $1.50. In this example, then, the clip limit is rightsized to $1.50.

With the clip limit rightsized to the smaller of the targeted return and a maximum acceptable loss amount, the investor in a clipper has guaranteed to limit losses to an acceptable level, without requiring a further hedge on the clipper. Indeed, such a clipper is so efficient at containing speculative losses, that a further hedge would be expensive and redundant. By way of illustration, assume that the long Buyer of the $1.50 clipper with a start price of 100 decides to add a traditional hedge to protect against downside movement. The traditional hedge may encompass any one of the following actions: 1) short sell the underlying stock of XYZ at the price of $105.37, at a required capital outlay of $105.37, 2) purchase a put on XYZ with a strike price of $105.37, at a required premium outlay of $3, or 3) sell a forward/future on stock XYZ at the price of $105.37, with a required margin outlay of over $21. In each of these instances, the clipper cannot possibly lose more than $1.50. Each of these hedges, however, requires outlays of capital that would exceed the “all-in” margins of $1.50 intrinsic to the clipper. Furthermore, if the underlying reverses direction with a large movement, each of these hedges can themselves cause losses that exceed more than $1.50 to the overall hedged position.

Thus, from a capital efficiency perspective (defined as number of units of capital deployed per unit of targeted return), and from a risk efficiency perspective (defined as the maximum number of units of capital that is acceptably lost per unit of targeted return), clippers are guaranteed to be, on a mutually supportive basis, capital-to-targeted return-to-risk efficient. Put another way, with clippers, the maximum amount of capital required to be deployed as “all-in” margins, and the maximum amount of targeted return, and the maximum amount at risk for acceptable loss, are guaranteed to be identical, and the same.

Sometimes a Buyer and Seller will specify a “notional amount” of an Underlying that is referenced by the Clipper. A “notional amount” is a face value for a referenced Underlying that is referred to by the counterparties as a basis for exchanging cashflows according to a financial formula. Those trained in the prior art of capital markets trading know and understand that notional amounts are simply conveniences of hypothecated amounts of money that provide a means by which Underlyings, or derivatives on those Underlyings, can be exchanged.

At a clearinghouse, the relationship of required Initial Margin and Variation Margin to the “standard manufacture” of a long or short position in a tailed risk instrument like an Underlying, forward/future, option, or swap is based on the expected “Value at Risk” or SPAN stress measurement of loss. It is impossible for a clearinghouse to require only a finite pre-specified amount of Initial Margin as All-In Margin at the inception of a tailed risk instrument trade, and not avail itself later of a Variation Margin call if the solvency of the trade is suddenly at risk. In contrast, the equivalency of All-In Margins with the Clip Limit Amount is a unique property of the “standard manufacture” of a Clipper. Such All-In Margins guarantee capital adequacy to the clearinghouse for Clipper trades in all market circumstances.

As briefly recited before, the method of present invention can be performed by means other than a computer processor or system. For example, the method can be performed by verbal or written communication, or telecommunications. An individual telephones a broker to place an order for an intended Clipper trade. The order must specify a referenced Underlying, a Start-Time of the Clipper Life, and End-Time of the Clipper life, a Mid-Bar, Clip Limit, and Quantity. The broker then tries to obtain a matching order from another party to execute a trade. Upon finding a matching order, the trade is then executed. A settlement basis is then applied at the end of the Clipper life and is used to determine the gains or losses experienced by each counterparty.

Sometimes a Buyer and Seller will trade a Clipper derivative as a privately negotiated transaction. In the parlance of capital markets trading, this is called over-the-counter derivatives trading. The payment function of such a Clipper is then simply a financial obligation between the two counterparties. Frequently, in over-the-counter derivatives trading, a superior credit counterparty will require collateral as a performance bond to guarantee an expected level of losses from a trade that could be experienced by an inferior credit counterparty. This is because a superior credit counterparty is expected to have a greater ability to withstand a high frequency or high severity of liabilities with persistent financial strength for a longer period of time than would be expected from an inferior credit counterparty. In over-the-counter trading, such an arrangement of collateral would be applicable to Clipper derivatives as well as to other types of derivatives. Such an arrangement of collateral is used to mitigate what is called “counterparty credit risk.”

Clippers however, are derivatives that have limited gain and loss potential, and thus enable a type of “escrow” guarantee that can be made by a third party to a Buyer and to a Seller. This “escrow” guarantee is funded by “all-in” margins that would be furnished by the Buyer and the Seller to the third party, in an amount that is equal to the maximum possible loss that can be experienced in the Clipper trade. This amount is also equal to the clip limit amount specified at the inception of the trade, multiplied by any number of Clipper units that are specified. Thus the maximum value of the gain or loss of the payoff function of the Clipper, as paid by Buyer to Seller, or as paid by Seller to Buyer, can be fully funded by the amount of “all-in” margins furnished as escrow to such a third party, as a new guarantee by the third party to the Buyer and Seller.

When the Buyer and Seller no longer legally depend on each other for the payment of an obligation, but legally depend on the third party for that same payment, the obligation is said to be “novated.” Thus, when “all-in” margins are furnished to a third party to facilitate 100% of the financing of the obligation of the Clipper, the “counterparty credit risk” of the Buyer defaulting to the Seller and of the Seller defaulting to the Buyer has been eliminated, but replaced by a new “counterparty credit risk” of the third party defaulting to either the Buyer or to the Seller. Under novation, the third party is obligated to pay to the Buyer or Seller the payoff function of the Clipper, regardless of whether or not collections of “all-in” margins have taken place. But the third party can nevertheless fully fund the worst possible outcome of a Clipper function under novation by collecting “all-in” margins from both Buyer and Seller, and guaranteeing solvency of the trades.

A clearinghouse is a type of central counterparty that provides financial guarantees to market participants for gains and losses for trades that are executed over-the-counter, on an electronic trading facility, or on an organized exchange. A clearinghouse can serve as an “escrow” agent to guarantee Clipper gains and losses to Buyers and Sellers, but also can serve as a “novation” counterparty to guarantee such gains and losses. To guarantee Clippers, a clearinghouse can establish a novel kind of “debit card” environment, where Buyers and Sellers are required to furnish “all-in” margins to the clearinghouse in amounts equal to the known clip limit amounts, before the clearinghouse agrees to novate the trade. In such a “debit card” environment, the clearinghouse guarantees that the furnished margins are sufficient to meet any obligation that may arise from the payment function of the Clipper.

There are many venues on which a Clipper trade can be matched between Buyer and Seller. One way is for a Clipper to be specified as an over-the-counter derivative between the two counterparties, and incepted with a customized, private agreement. Another way is for a Clipper to be specified in a standardized, listed contract, on an electronic trading facility, that can legally facilitate either an over-the-counter derivative, or an exchange-traded derivative, between the two counterparties.

| | J | K | L |
|---|---|---|---|
| 1 | For Adverse Movement . . . | PQR Underlying | |
| 2 | Expected Maximum Loss | Size | 30 |
| 3 | | Confidence Interval | 0.95 |
| 4 | Clip Limit | Size | 10 |
| 5 | | Confidence Interval | 0.65 |
| 6 | Remaining Range | Size | = L2-L4 |
| 7 | | Confidence Interval | = L3-L5 |
| 8 | Value of Basis Risk | | = ABS (L6 * L7) |

| | J | K | L |
|---|---|---|---|
| 6 | Remaining Range | Size | = 20 |
| 7 | | Confidence Interval | = .30 |
| 8 | Value of Basis Risk | | = 6 |

Matching of standardized, listed contracts on an electronic trading facility can take place in many different ways. One popular matching algorithm that has been utilized for futures, options, swaps, and other derivatives in the prior art automatically matches the side of Buyer (or Seller) posting “the earliest submitted resident order among all such orders quoting the best price” to incoming orders of the opposing side of Seller (or Buyer) that specify the same resident price “or better.”

Thus a Buyer listing a resident order for a Clipper on an electronic trading facility for a referenced underlying, with a starting time and date, an expiration time and date, a clip limit amount, and a starting price, for a specified number of units, can be a bid at the “best price,” that is, the highest price, and at the same time, be the earliest order submitted and still persisting at that price at the time a Seller submits an order. With this order, the Seller indicates an intention as an aggressor to match at least one unit of the specified number of units of the listed units of the resident order of the Buyer. The electronic trade facility then matches the minimum number of units that are shared between the maximum number of available units of the Buyer order, and the maximum number of available units of the Seller order.

In a similar fashion, a Seller listing a resident order for a Clipper on an electronic trading facility for a referenced underlying, with a starting time and date, an expiration time and date, a clip limit amount, and a starting price, for a specified number of units, can be a bid at the “best price,” that is, the highest price, and at the same time, be the earliest order submitted and still persisting at that price at the time a Buyer submits an order. With this order, the Buyer indicates an intention as an aggressor to match at least one unit of the specified number of units of the listed units of the resident order of the Seller. The electronic trade facility then matches the minimum number of units that are shared between the maximum number of available units of the Buyer order, and the maximum number of available units of the Seller order.

Regardless as to whether the Clipper is executed over-the-counter, on an electronic trading facility, or on an organized exchange, the Clipper is settled the same way. An observed price for the underlying at the time of Clipper expiration is recorded and logged. The Start Price for the Clipper is then subtracted from this observed price of the underlying, to obtain an original difference in value. The absolute value of this original difference is detached from the positive or negative sign of this original difference, and both are saved for further steps of application of the unitary Clipper function. If the absolute value of the original difference exceeds the clip limit amount for the Clipper, the clip limit amount itself serves as the interim value of settlement. If the absolute value of the original difference does not exceed the clip limit amount for the Clipper, then the absolute value itself serves as the interim value of the settlement. The saved positive or negative sign of the original difference is then attached to the interim value of the settlement, to create the final settlement value for each unit of the Clipper in the trade. Finally, the Buyer pays the Seller if the sign of the final settlement value is negative, and the Seller pays the Buyer if the final settlement value is positive. If there are multiple units of Clipper that have been traded, this final settlement value paid or received by Buyer or Seller is multiplied by the number of units of the Clipper in the trade.

| | N | O |
|---|---|---|
| 1 | Targeted Return | 2 |
| 2 | Maximum Acceptable Loss Amount | −1.50 |
| 3 | Clip Limit Amount | = MIN((ABS(O1), (ABS(O2)) |

Clippers are useful for investors who have a measureable prediction of expected targeted return, and a measureable prediction of finite time horizon of when that return is expected to be realized. Clippers can be used as complete substitutes for underlying financial instruments, without requiring any change in investment execution, strategy, tactics, style, or Underlying portfolio philosophy. Clippers do require investors to be disciplined in their specifications of targeted return and time horizon, but otherwise will facilitate almost any kind of strategy that can be practiced in the investment world.

Thus, from a capital efficiency perspective, defined as number of units of capital deployed per targeted unit of return, and from a risk efficiency perspective, defined as number of units of capital deployed per targeted unit of return, that must be funded as margins by the investor at the inception of the trade.

Some practitioners in the prior art of capital markets may compare clippers superficially to certain types of combinations of listed options, and note that clippers might share some properties with such listed option combinations. An unbiased observer of the derivatives markets, however, will readily detect such significant differences between the two fundamental types of derivative instrument that such comparisons would be rendered moot.

In the United States, listed options and listed futures on individual stocks are traded on regulated exchanges, and cleared by the Options Clearing Corporation. Listed options that are exercised “in the money” are required under United States law to have a security delivered against it. We prove in the following argument that one cannot deliver a security against the payoff function of a clipper in the same way that one may deliver one against that of a standard option, future, or any combination thereof. This proof is strong evidence that the clipper has never existed in the prior art, because if the clipper had existed, it would be infeasible to deliver a security against it. Indeed, because of significant basis risk, a clipper can only be cash-settled. We state this proposition below:
1. Let X be a contract whose terms can be described entirely by the following three components: Payment or receipt of some fixed amount of money, which may be zero.
2. The obligation to make a transaction or a finite series of transactions on the underlying security U at expiration (as in a future). The terms of these obligatory transactions are independent of the price of U at or before expiration.
3. The right (but not the obligation) to make a transaction or a finite series of transactions on U at expiration (as in an option). The terms of these optional transactions are independent of the price of U at or before expiration.

Let F[P] represent the payoff function of a clipper on an underlying security U with mid-bar M and clip limit C, where M>C. Then the payoff function of X is not equal to F. Note: Throughout this proof, we will ignore issues such as extra transaction costs (like fees) and the possible failure to deliver the security. We also assume that the underlying security is completely liquid prior to expiry and that it trades at a single value at any time, i.e. the spread on the price of the underlying is nil.

PROOF: Let G represent the overall payoff function of X. G is a function of the end price P of the underlying security. Note that we may break down this payoff function into three payoff functions G=G₁+G₂+G₃, where each G₁ corresponds to one of the three components listed above.

By definition, G₁[P]=K₁, where K₁ is some constant monetary value.

The obligations described in #2 are, more specifically, commitments stating that the holder must buy or sell some amount of U at a specified price. We show an example of a collection of these commitments in Proof FIG. 1 with buys listed in cells AA3:AC7 and sells listed in cells AE3:AG7. The numbers of shares for each are listed in columns AA and AE, the specified prices are listed in columns AB and AF, and the monetary impacts of the transactions are listed in columns AC and AG.

Proof FIG. 1

| | AA | AB | AC | AD | AE | AF | AG |
|---|---|---|---|---|---|---|---|
| 1 | Buys | | | | Sells | | |
| 2 | Number | Specified | Monetary | | Number | Specified | Monetary |
| | of Shares | Price | Impacts | | of | Price | Impacts |
| | | | | | Shares | | |
| 3 | 48 | $91.31 | =−AA3 * AB3 | | 54 | $94.51 | =AE3 * AF3 |
| 4 | 83 | $102.92 | =−AA4 * AB4 | | 12 | $100.41 | =AE4 * AF4 |
| 5 | 70 | $94.11 | =−AA5 * AB5 | | 51 | $93.38 | =AE5 * AF5 |
| 6 | 51 | $100.04 | =−AA6 * AB6 | | 88 | $99.19 | =AE6 * AF6 |
| 7 | 27 | $100.27 | =−AA7 * AB7 | | 32 | $97.92 | =AE7 * AF7 |

We show the results of this example in Proof FIG. 2:

Proof FIG. 2

| | AA | AB | AC | AD | AE | AF | AG |
|---|---|---|---|---|---|---|---|
| 1 | Buys | | | | Sells | | |
| 2 | Number | Specified | Monetary | | Number of | Specified | Monetary |
| | of Shares | Price | Impacts | | Shares | Price | Impacts |
| 3 | 48 | $91.31 | ($4,382.88) | | 54 | $94.51 | $5,103.54 |
| 4 | 83 | $102.92 | ($8,542.36) | | 12 | $100.41 | $1,204.92 |
| 5 | 70 | $94.11 | ($6,587.70) | | 51 | $93.38 | $4,762.38 |
| 6 | 51 | $100.04 | ($5,102.04) | | 88 | $99.19 | $8,728.72 |
| 7 | 27 | $100.27 | ($2,707.29) | | 32 | $97.92 | $3,133.44 |

Let N represent the difference between the number of shares the holder is obliged to buy and the number he is obliged to sell (see cell AB9 in Proof FIGS. 3 and 4). At expiry, this component of the contract leaves the holder with N shares of U (if N is negative, this means he is short |N| shares of U). So if K₂ is the net of all the cash received and paid in the underlying transactions (see cell AB10 in Proof FIGS. 3 and 4), then G₂[P]=K₂+N*P. We show in Proof FIG. 3 and results in Proof FIG. 4.

Proof FIG. 3

| | AA | AB |
|---|---|---|
| 9 | N = Net Shares | = SUM(AA3:AA7) − SUM(AE3:AE7) |
| 10 | K₂ = Total Received/(Paid) | = SUM(AG3:AG7) + SUM(AC3:AC7) |

Proof FIG. 4

| | AA | AB |
|---|---|---|
| 9 | N = Net Shares | 42 |
| 10 | K₂ = Total Received/(Paid) | ($4,389.27) |

The third component is comprised of standard European options—contracts which give the holder the right to buy (as in a call) or sell (as in a put) the underlying security U at a specified price. We claim the following: with respect to the final payoff function, the right to buy one share of U at price S is equivalent to a combination of the obligation to buy one share and the right to sell one share at S. This is because the combination of these two contracts gives the holder two choices:
1) If the sell option is not exercised, then the holder simply buys one share of U.
2) If the sell option is exercised, then the holder buys one share of U and sells that share at the same price. Because we are assuming that there is zero risk of delivery failure and no extra transaction costs, and because these two offsetting transactions are executed at the same price, this yields the same payoff (zero) as doing nothing.

Because the combination leaves the holder with equivalent choices to those of the call option, the payoff functions of the combination and of the call option are the same.

Hence, without loss of generality, we may assume that all the options comprising the third component are puts (since we may decompose any call option into the right to sell and the obligation to buy, including the latter in component #2). We show an example of a collection of puts in cells AJ3:AK7 in Proof FIG. 5. The numbers of shares for each put are listed in column AJ and the specified prices (these are called “strike prices” in the options world) are listed in column AK. Let S* be the maximum specified price for these options—this is shown in cell AK9, with the formula for this value in Proof FIG. 6 and the result in Proof FIG. 7.

Proof FIG. 5

| | AJ | AK |
|---|---|---|
| 1 | Put Options | |
| 2 | Number of | Specified Price |
| | Shares | |
| 3 | 33 | $100.76 |
| 4 | 52 | $106.64 |
| 5 | 70 | $99.40 |
| 6 | 57 | $104.98 |
| 7 | 64 | $100.23 |

Proof FIG. 6

| | AJ | AK |
|---|---|---|
| 9 | S* = Max | = MAX(AK3:AK7) |
| | Specified Price | |

Proof FIG. 7

| | AJ | AK |
|---|---|---|
| 9 | S* = Max | $106.64 |
| | Specified Price | |

Then if P>S* (where P is the end price of the underlying security, shown in cell AK11 in FIG. 8), exercising any one of these options would result in a loss of S*−P per share. Therefore, in this case, no option will be exercised, so the payoff function of every option is zero beyond S*. We demonstrate an example of this below, with an appropriate value for P (i.e. greater than S*) in cell AK11. The negative payoffs that would result from exercise of the options are listed in cells AL3:AL7, while the real payoffs of the options are listed in cells AM3:AM7 (note that it is zero for all the options, because of how P was selected)—formulas are shown in FIG. 9 and results are shown in FIG. 10.

Proof FIG. 8

| | AJ | AK |
|---|---|---|
| 11 | P = Underlying | $108.80 |
| | End Price | |

Proof FIG. 9

| | AL | AM |
|---|---|---|
| 2 | Payoff If Exercised | Actual Option |
| | | Payoff |
| 3 | =(AK3 − $AK$11) * AJ3 | =MAX(AL3,0) |
| 4 | =(AK4 − $AK$11) * AJ4 | =MAX(AL4,0) |
| 5 | =(AK5 − $AK$11) * AJ5 | =MAX(AL5,0) |
| 6 | =(AK6 − $AK$11) * AJ6 | =MAX(AL6,0) |
| 7 | =(AK7 − $AK$11) * AJ7 | =MAX(AL7,0) |

Proof FIG. 10

| | AL | AM |
|---|---|---|
| 2 | Payoff If Exercised | Actual Option |
| | | Payoff |
| 3 | ($265.39) | $0.00 |
| 4 | ($112.23) | $0.00 |
| 5 | ($658.25) | $0.00 |
| 6 | ($217.53) | $0.00 |
| 7 | ($548.69) | $0.00 |

G₃ is therefore a bounded function in the domain P>S*. G₁ is clearly bounded in this domain because it is constant everywhere. G₂ is only bounded in this domain if N=0 (where N is defined as in the difference between the number of shares the holder is obliged to buy and the number he is obliged to sell). Therefore, it must be true that N=0 because we need the sum of all three to be bounded in order for G to equal the clipper payoff function F.

The clipper payoff function has a constant value in the domain S<M−C (where M is the mid-bar of the clipper and C is the clip limit)—this is referred to as the left “end flat” of the clipper payoff function. We will show that the payoff function of X has no such end flat, thereby completing our proof that G+F.
1) We claim that the payoff function of each put option is decreasing. We first note that not exercising an option always yields zero payoff regardless of the underlying end price. Therefore, if exercising the option would yield a negative payoff, a holder will choose not to exercise it and take the zero payoff. Hence the payoff function of an option is greater than or equal to zero everywhere. Now look at two distinct possible underlying end prices P₁ and P₂, where we assume without loss of generality that P₁<P₂. We compare the payoffs of a put option at these underlying end prices. There are two cases: Suppose that the payoff at P₂ is obtained without exercise of the option. This implies a zero payoff, so because the payoff everywhere is at least zero, the payoff at P₁ is greater than or equal to the payoff at P₂.
2) Suppose that the payoff at P₂ is obtained with exercise of the option. Then exercising the option at P₁ yields a strictly greater payoff. This is because the value of each share that the holder is short after exercise is less (specifically P₂−P₁ less) than in the case where the end price is P₂. Hence it costs the holder less to buy back the underlying security, strictly increasing his net profit.

In both cases, the payoff at the smaller underlying end price is greater than or equal to the payoff at the larger underlying end price. Therefore, the payoff function is decreasing.

Suppose that the set of options in component #3 is not empty. The right to sell at zero is an option which no trader would ever exercise rationally (since it means trading something for nothing), so we may assume that every specified price is strictly positive. For any one of the options comprising component #3 of X, let P_{U} be the minimum of its specified price S and M−C. In the example below, we show M in cell AR1, C in cell AR2, S in cell AR3, and P₀ in cell AR5 (the formula is in Proof FIG. 11 and the value is in Proof FIG. 12).

Proof FIG. 11

| | AQ | AR |
|---|---|---|
| 1 | M = Mid-Bar | $100.00 |
| 2 | C = Clip Limit | $5.00 |
| 3 | S = Specified Price | $97.00 |
| 4 | | |
| 5 | P₀ | = MIN(AR3, AR1 − AR2) |

Proof FIG. 12

| | AQ | AR |
|---|---|---|
| 5 | P₀ | $95.00 |

Because P₀ is less than or equal to S, exercising the option at this price yields a non-negative payoff—each share is bought for P₀ but is sold for S, yielding a per-share profit of S−P₀. So the payoff at this end price can be obtained with exercise. Hence P₀ satisfies the conditions of case #2 in the above proof that the payoff function of a put option is decreasing. For case #2, we showed that if P<P₀, the payoff of the option at P is strictly greater than the payoff at P₀. We give an example of a possible value for P that is less than P₀ in cell AR9, while P₀ is listed again in cell AR8. The payoffs per share for each possible end price are shown in cells AS8:AS9.

Proof FIG. 13

| | AQ | AR | AS |
|---|---|---|---|
| 7 | Name | Price | Payoff Per |
| | | | Share |
| 8 | P₀ | = AR5 | = AR3 − AR8 |
| 9 | P | $91.02 | = AR3 − AR9 |

Proof FIG. 14

| | AQ | AR | AS |
|---|---|---|---|
| 7 | Name | Price | Payoff Per |
| | | | Share |
| 8 | P₀ | $95.00 | $2.00 |
| 9 | P | $91.02 | $5.98 |

Since the payoff at P of this option is strictly greater than the payoff at P₀, and all the other option payoff functions are decreasing, we see that G₂[P]>G₂[P₀]. Hence G[P]>G[P₀] since both other components of the total payoff function are constant. So although we have chosen P and P₀ to be on the “end flat” of F (because both were defined to be less than or equal to M−C), we see that they are not on an end flat of G since the payoff at P is not equal to the payoff at P₀. Hence C≠F.

Now suppose that the set of options in component #3 is empty. In this case, G₃=0, implying that G is constant. But the clipper payoff function F is not constant, so again G≠F. Since we have now eliminated all possibilities, the proposition is proven.

This proof establishes that the clipper cannot be replicated by simply purchasing combinations of standard instruments that are based on delivery of the underlying security. In order to construct the clipper payoff function from such instruments, it is necessary to write (sell) at least one option contract, thereby exposing a trader to pin risk that is not present in a clipper.

Some practitioners in the prior art of capital markets may still compare clippers superficially to certain types of combinations of listed options, and ask whether clippers might share some “pin risk” properties with such listed option combinations. An unbiased observer of the derivatives markets, however, will readily detect such significant differences between the two fundamental types of derivative instrument that such comparisons of pin risk easily show that clippers do not suffer from the pin risk of listed options.

In the following section, we attempt to replicate a clipper by buying a put, selling a call and buying a future. We show how pin risk comes into play and leads to tail risk that is not present in the clipper.

Suppose that M is the mid-bar, C is the clip limit, and U is the underlying security of the clipper we are trying to replicate. Then we buy a put O^{P} at strike price M−C, sell a call O^{C} at strike price M|C, and buy a future F with M as our specified price—all of these contracts should be for the same expiry time and for the same underlying security as that of the clipper.

Pin risk occurs when the end price of the underlying security of an option is very close to the strike price of that option, since the writer cannot be sure whether or not the holder of the option will choose to exercise it. If the writer predicts incorrectly what the holder will do, he is left with an undesired open position in the underlying that exposes him to great risk if he cannot trade out of it.

Suppose that the underlying end price P is very close to M+C. Then we will certainly choose not to exercise O^{P} since doing so will yield a per-share loss of (M−C)−P. However, we cannot be sure whether the holder of O^{C} will choose to exercise their option. We have the following two possibilities:
1) We believe that the holder will not exercise O^{C}. If we are correct in our prediction, we should short sell one lot of U prior to expiry, since neither option will be exercised and we will only be obliged by F to buy one lot of U, thereby leaving us flat in the underlying security.
2) We believe that the holder will exercise O^{C}. If we are correct in our prediction, we need not have any open position in U prior to expiry, since we will be obliged by F to buy one lot of U and by O^{C} to sell one lot of U. The combination of these transactions leaves us flat in the underlying security.

In either one of these cases, if our prediction is wrong we are left with an undesired open position in U:
1) If the holder exercises O^{C} when we expected exercise, we are short one lot of U following expiry.
2) If the holder does not exercise O^{C} when we expected exercise, we are long one lot of U following expiry.

In either case, we are left exposed to potential tail risk unless we are unable to trade out of our position immediately following expiry (suppose expiry occurred on a Friday and we must wait until the following Monday). In case #1, if the price of U shoots upward before we can trade out of our position, we will experience heavy losses. In case #2, if the price of U plummets downward before we can trade out of our position, we will also experience heavy losses.

This sort of risk is not an issue when using a clipper instead of this combination of derivative instruments. Because no delivery of the underlying security is required by a clipper, pin risk, by definition, cannot occur. Therefore, the buyer or seller of the clipper is protected from large possible losses that can occur with sudden swings in the price of the underlying security.

1. A computerized method and system of specifying a Clipper financial instrument to be traded between a Buyer and Seller, comprising the steps of:
a) identifying a first trader acting as a Buyer of the Clipper as a counterparty to a potential Seller, the identification being made by any trader or third party,
b) identifying a second trader acting as a Seller of the Clipper as a counterparty to a potential Buyer, the identification being made by any trader or third party,
c) co-selecting a referenced underlying for the Clipper, by the Buyer and Seller,
d) co-selecting a starting time and date for the Life of the Clipper, by the Buyer and Seller,
e) co-selecting an expiration time and date for the Life of the Clipper, by the Buyer and Seller,
f) co-selecting a clip limit amount for the Clipper, by the Buyer and Seller,
g) co-selecting a starting price for the Clipper, by the Buyer and Seller, and
h) co-selecting a matched number of units of the Clipper that can be exchanged, by the Buyer and Seller.

2. The method of claim 1, further comprising the step of the Buyer and the Seller co-selecting a notional amount of underlying value for each unit of the Clipper that can be exchanged.

3. The method of claim 1, further comprising the step of both the Buyer and the Seller furnishing margins that are equal to the amount of the clip limit for each unit of the Clipper that can be exchanged to a third party financial institution.

4. The method of claim 1, further comprising the step of both the Buyer and the Seller furnishing margins that are equal to the amount of the clip limit for each unit of the Clipper that can be exchanged to a clearinghouse.

5. A computerized method and system of trading a Clipper financial instrument between a Buyer and Seller, on an electronic trading facility, comprising the steps of:
a) listing, by a buying counterparty, a resident order of a Clipper for a referenced Underlying, a starting time and date, an expiration time and date, a clip limit amount, and a starting price, for a specified number of units or lots,
b) indicating, by a selling counterparty, an intention as an aggressor to match at least one unit or lot of the specified number of units or lots of the listed resident order of the buying counterparty, and
c) matching, by an electronic trading facility, the minimum number of units shared among the maximum of those listed by the Buyer and the maximum of those indicated by the Seller.

6. The method of claim 5, further comprising the step of the Buyer and the Seller co-selecting a notional amount of underlying value for each unit of the Clipper that can be traded.

7. The method of claim 5, further comprising the step of both the Buyer and the Seller furnishing margins that are equal to the amount of the clip limit for each unit of the Clipper that can be traded to a third party financial institution.

8. The method of claim 5, further comprising the step of both the Buyer and the Seller furnishing margins that are equal to the amount of the clip limit for each unit of the Clipper that can be traded to a clearinghouse.

9. A computerized method and system of trading a Clipper financial instrument between a Buyer and Seller, on an electronic trading facility, comprising the steps of:
a) listing, by a selling counterparty, a resident order of a Clipper for a referenced
Underlying, a starting time and date, an expiration time and date, a clip limit amount, and a starting price, for a specified number of units or lots,
b) indicating, by a buying counterparty, an intention as an aggressor to match at least one unit or lot of the specified number of units or lots of the listed resident order of the buying counterparty, and
c) matching, by an electronic trading facility, the minimum number of units shared among the maximum of those listed by the Buyer and the maximum of those indicated by the Seller.

10. The method of claim 9, further comprising the step of the Buyer and the Seller co-selecting a notional amount of underlying value for each unit of the Clipper that can be traded.

11. The method of claim 9, further comprising the step of both the Buyer and the Seller furnishing margins that are equal to the amount of the clip limit for each unit of the Clipper that can be traded to a third party financial institution.

12. The method of claim 9, further comprising the step of both the Buyer and the Seller furnishing margins that are equal to the amount of the clip limit for each unit of the Clipper that can be traded to a clearinghouse.

13. A computerized method and system of settling a Clipper financial instrument already traded between a Buyer and Seller, comprising the steps of:
a) obtaining the Clipper trade information with respect to Buyer and Seller, a referenced underlying, a starting time and date, an expiration time and date, a clip limit amount, and a starting price, for the specified number of Clipper units,
b) specifying an observed price for the referenced underlying at the time of expiration,
c) subtracting the starting price for the Clipper from the observed price at expiration, to obtain an original difference,
d) determining the absolute value of the original difference,
e) saving the sign of the original difference,
f) determining whether the absolute value of the original difference exceeds the clip limit amount for the Clipper. And, if positive, establish an interim settlement value that is equal to the absolute value of the clip limit, and, if negative, establish an interim settlement value that is equal to the absolute value of the original difference,
g) establishing an interim settlement value that is equal to the absolute value of the clip limit if the result in step f is positive,
h) establishing an interim settlement value that is equal to the absolute value of the original difference, if the result in step f in negative
i) reattaching the saved sign of the original difference to the interim settlement value, to obtain the final settlement value,
j) requiring the Buyer to pay the Seller the final settlement value if the sign is negative, or else requiring the Seller to pay the Buyer the final settlement value if the sign is positive, for each of the Clipper units.

14. The method of claim 13, further comprising the step of a third party facilitating the payment of settlement from loser to winner and releasing any remaining margins to the respective counterparties.

15. The method of claim 13, further comprising the step of a clearinghouse facilitating the payment of settlement from loser to winner and releasing any remaining margins to the respective counterparties.

16. A computerized method and system of identifying, trading and settling a Clipper financial instrument, comprising the steps of:
a) identifying, by any trader or third party, a first trader acting as a Buyer of the Clipper as a counterparty to a potential Seller,
b) identifying, by any trader or third party, a second trader acting as a Seller of the Clipper as a counterparty to a potential Buyer,
c) co-selecting, by the Buyer and Seller, a referenced underlying for the Clipper,
d) co-selecting, by the Buyer and Seller, a starting time and date for the Life of the Clipper,
e) co-selecting, by the Buyer and Seller, an expiration time and date for the Life of the Clipper,
f) co-selecting, by the Buyer and Seller, a clip limit amount for the Clipper,
g) co-selecting, by the Buyer and Seller, a starting price for the Clipper,
h) co-selecting, by the Buyer and Seller, a matched number of units for the Clipper that can be exchanged,
i) exchanging, by the Buyer and Seller, the Clipper with the above co-selected parameters,
j) specifying, by the Buyer, Seller, or any third party, an observed price for the referenced underlying at the time of expiration, and
k) settling, by the Buyer, Seller, or any third party, at that observed price.

17. The method of claim 16, wherein settling comprises the steps of:
a) subtracting, by the Buyer, Seller, or any third party, the starting price for the traded Clipper from the observed price at expiration, to obtain an original difference,
b) determining, by the Buyer, Seller, or any third party, the absolute value of the original difference,
c) saving, by the Buyer, Seller, or any third party, the sign of the original difference,
d) determining, by the Buyer, Seller, or any third party, whether the absolute value of the original difference exceeds the clip limit amount for the Clipper. If so, establish an interim settlement value that is equal to the absolute value of the clip limit. If not, establish an interim settlement value that is equal to the absolute value of the original difference,
e) reattaching, by the Buyer, Seller, or any third party, the saved sign of the original difference to the interim settlement value, to obtain the final settlement value for each unit of the exchanged Clipper,
f) requiring, by the Buyer, Seller, or any third party, the Buyer to pay the Seller the final settlement value if the sign is negative, or else requiring the Seller to pay the Buyer the final settlement value if the sign is positive, for each unit of the exchanged Clipper.

18. The method according to claim 16 wherein the Buyer is listing a resident order of a Clipper for the referenced underlying, for the starting time and date, for the expiration time and date, and for the clip limit amount, at the starting price, for a specified number of units, and the Seller is indicating an intention as an aggressor to match at least one unit of those listed by the buying counterparty, and the Buyer, Seller, or a third party is matching the minimum number of units shared between the maximum of those listed by the Buyer and the maximum of those indicated by the Seller.

19. A financial instrument comprising of a derivative referencing an underlying, whose Buyer or Seller position has a settlement value that is determined by subtracting the negotiated Start Price of the derivative from the observed value of the underlying as of the expiration time of the derivative, and further capping that difference by a constant absolute value of gain or loss, where a settlement value of gain requires payment of that capped difference from Buyer to Seller, and where a settlement value of loss requires payment of that capped difference from Seller to Buyer.

20. A method of identifying, trading, and settling a Clipper financial instrument, comprising the steps of:
a) identifying, by any trader or third party, a first trader acting as a Buyer of the Clipper as a counterparty to a potential Seller,
b) identifying, by any trader or third party, a second trader acting as a Seller of the Clipper as a counterparty to a potential Buyer,
c) co-selecting, by the Buyer and Seller, a referenced Underlying for the Clipper,
d) co-selecting, by the Buyer and Seller, a starting time and date for the Life of the Clipper,
e) co-selecting, by the Buyer and Seller, an expiration time and date for the Life of the Clipper,
f) co-selecting, by the Buyer and Seller, a clip limit amount for the Clipper,
g) co-selecting, by the Buyer and Seller, a starting price for the Clipper,
h) co-selecting, by the Buyer and Seller, a matched number of units for the Clipper that can be exchanged,
i) exchanging, by the Buyer and Seller, the Clipper with the above co-selected parameters,
j) specifying, by the Buyer, Seller, or any third party, an observed price for the referenced Underlying at the time of expiration, and settling at that observed price, and
k) settling, by the Buyer, Seller, or any third party, at that observed price.

21. The method of claim 20, wherein settling comprises the steps of:
a) subtracting, by the Buyer, Seller, or any third party, the starting price for the traded Clipper from the observed price at expiration, to obtain an original difference,
b) determining, by the Buyer, Seller, or any third party, the absolute value of the original difference,
c) saving, by the Buyer, Seller, or any third party, the sign of the original difference,
d) determining, by the Buyer, Seller, or any third party, whether the absolute value of the original difference exceeds the clip limit amount for the Clipper. If so, establish an interim settlement value that is equal to the absolute value of the clip limit. If not, establish an interim settlement value that is equal to the absolute value of the original difference,
e) reattaching, by the Buyer, Seller, or any third party, the saved sign of the original difference to the interim settlement value, to obtain the final settlement value for each unit of the exchanged Clipper,
f) requiring, by the Buyer, Seller, or any third party, the Buyer to pay the Seller the final settlement value if the sign is negative, or else requiring the Seller to pay the Buyer the final settlement value if the sign is positive, for each unit of the exchanged Clipper.
